(19) United States
(12) Patent Application Publication
(10) Pub. No.: US 2024/0397589 A1
(43) Pub. Date: Nov. 28, 2024

(54) INTERLOCK DEVICE OF MICROWAVE OVEN AND MICROWAVE OVEN

(71) Applicants: GUANGDONG MIDEA KITCHEN APPLIANCES MANUFACTURING CO., LTD., FOSHAN (CN); MIDEA GROUP CO., LTD., FOSHAN (CN)

(72) Inventors: Shuaishuai WEI, FOSHAN (CN); Yanqi WU, FOSHAN (CN)

(21) Appl. No.: 18/692,828

(22) PCT Filed: Jun. 1, 2023
(86) PCT No.: PCT/CN2023/097773

§ 371 Date: Mar. 18, 2024

(30) Foreign Application Priority Data
Jun. 1, 2022 (CN) 202210623214.9
Jun. 1, 2022 (CN) 202221380628.5
Jun. 1, 2022 (CN) 202221380872.1

(51) Int. Cl. H05B 6/66; E05B 65/00; F24C 15/02

(52) U.S. Cl. CPC H05B 6/666; E05B 65/00; F24C 15/022

(57) ABSTRACT

Provided are an interlock device of a microwave oven and the microwave oven. The interlock device includes: a first door hook; an interlock support provided with a monitoring switch, a first microswitch, and a second microswitch; and a first lever and a second lever that are rotatably mounted at the interlock support, respectively. The first door hook is configured to sequentially drive the first lever and the second lever to rotate during door closing of the microwave oven to allow the second lever to sequentially trigger the first microswitch and the second microswitch after the monitoring switch is triggered by the first lever.

### CROSS-REFERENCES TO RELATED APPLICATIONS

The present disclosure is a national phase application of International Application No. PCT/CN2023/097773, filed on Jun. 1, 2023, which claims priority to Chinese patent applications Nos. 202210623214.9, 202221380872.1, and 202221380628.5, filed on Jun. 1, 2022, the entire contents of which are incorporated herein by reference.

### FIELD

The present disclosure relates to the field of microwave oven technologies, and more particularly, to an interlock device of a microwave oven and a microwave oven.

### BACKGROUND

In the related art, a microwave oven adopts a microswitch layout for controlling a primary microswitch by an upper door hook of a movable door hook and controlling a secondary microswitch and a monitoring microswitch by a lower door hook during door closing. However, in the above-described manner of triggering the microswitches, a trigger sequence of the microswitches is prone to disorder during the door closing of the microwave oven, resulting in a potential safety hazard or affecting the service life of the microwave oven.

### SUMMARY

The present disclosure aims at solving at least one of the problems in the related art. To this end, one embodiment of the present disclosure provides an interlock device of a microwave oven. The interlock device is capable of avoiding disorder of a trigger sequence of switches.

One embodiment of the present disclosure provides an interlock device of a microwave oven. The interlock device can trigger switches orderly and occupies a small space. In addition, the interlock device has strong versatility and can effectively save costs.

One embodiment of the present disclosure provides a microwave oven having the above interlock device.

According to one embodiment of the present disclosure, the interlock device of the microwave oven includes: a first door hook; an interlock support provided with a monitoring switch, a first microswitch, and a second microswitch; and a first lever and a second lever that are rotatably mounted at the interlock support, respectively. The first door hook is configured to sequentially drive the first lever and the second lever to rotate during door closing of the microwave oven to allow the second lever to sequentially trigger the first microswitch and the second microswitch after the monitoring switch is triggered by the first lever.

According to the interlock device of the microwave oven of the embodiment of the present disclosure, the monitoring switch, the first microswitch, and the second microswitch are triggered sequentially through driving of the first door hook and orderly transmission of the first lever and the second lever, to avoid a problem of disorder of a trigger sequence of a plurality of switches. Therefore, both an open state and a closed state of a door body can be ensured to be detected accurately. In addition, damages to a circuit of the microwave oven or even safety accidents can be avoided, which is conducive to improving the service life of the microwave oven.

In addition, the interlock device of the microwave oven according to the above embodiment of the present disclosure can further have the following additional features.

According to some embodiments of the present disclosure, a rotational axis of the first lever is located at a side of a rotation axis of the second lever close to the first door hook.

According to some embodiments of the present disclosure, a rotational axis of the first lever and a rotational axis of the second lever are located at two sides of the first door hook perpendicular to a door closing direction, respectively.

According to some embodiments of the present disclosure, the first lever includes a first drive arm provided with a first drive portion configured to trigger the monitoring switch. The first door hook is further configured to abut with the first drive arm during the door closing of the microwave oven to drive the first lever to rotate in a first direction.

According to some embodiments of the present disclosure, the first lever further includes a second drive arm located at a side of the first drive arm close to the first door hook. The first door hook is further configured to: extend to a position between the first drive arm and the second drive arm during the door closing of the microwave oven; and abut with the second drive arm during door opening of the microwave oven to drive the first lever to rotate in a second direction opposite to the first direction.

According to some embodiments of the present disclosure, the interlock device further includes an elastic member connected to the interlock support and the first lever and having a first drive state. The elastic member is configured to apply a drive force for rotating the first lever in the first direction to the first lever in the first drive state to allow the second drive arm to drive the first door hook to move in a door closing direction.

According to some embodiments of the present disclosure, the elastic member further has a second drive state. The elastic member is further configured to apply a drive force for rotating the first lever in the second direction to the first lever in the second drive state. The first door hook is further configured to abut with the first drive arm during the door closing of the microwave oven to switch the elastic member from the second drive state into the first drive state.

According to some embodiments of the present disclosure, the second drive arm has a length smaller than a length of the first drive arm; and/or in an axial direction of the first lever, the second drive arm has a thickness smaller than a thickness of the first drive arm.

According to some embodiments of the present disclosure, the interlock support is provided with a first limit portion. The first limit portion is configured to abut with the first lever in a door closed state to block the first lever from rotating in the first direction.

According to some embodiments of the present disclosure, the interlock device further includes a door closing buffer assembly connected to the interlock support and the first drive arm. The door closing buffer assembly is configured to apply a buffer force to the first lever in a direction opposite to the first direction during the door closing of the microwave oven.

According to some embodiments of the present disclosure, the door closing buffer assembly includes: a buffer member having an end rotatably connected to the interlock support; and a connector rotatably mounted at the first drive arm by a predetermined angle relative to a drive surface of the first drive arm. Another end of the buffer member is rotatably connected to the connector. The drive surface is capable of abutting with the connector after the first lever rotates by the predetermined angle in the first direction during the door closing of the microwave oven, to drive the connector to rotate.

According to some embodiments of the present disclosure, the second lever includes: a first rotation arm configured to abut with the first door hook during the door closing of the microwave oven to drive the second lever to rotate in the second direction; and a second rotation arm and a third rotation arm that are configured to trigger the first microswitch and the second microswitch, respectively. The first rotation arm, the second rotation arm, and the third rotation arm are sequentially arranged in the second direction.

According to some embodiments of the present disclosure, at least two of the first rotation arm, the second rotation arm, and the third rotation arm are offset from each other in an axial direction of the second lever.

According to some embodiments of the present disclosure, the interlock support includes a support body and a cover body. The cover body cooperates with the support body to define a mounting space, and the first lever and the second lever are mounted in the mounting space. The monitoring switch is arranged at a side of the cover body facing away from the support body. The cover body has a first through hole for passage of the first drive portion of the first lever. One of the first microswitch and the second microswitch is arranged in the mounting space, and another one of the first microswitch and the second microswitch is arranged at the side of the cover body facing away from the support body. The cover body has a second through hole for passage of a second drive portion of the second lever.

According to one embodiment of the present disclosure, the interlock device includes: a first door hook; an interlock support provided with a first microswitch and a second microswitch; and a second lever rotatably mounted at the interlock support. The second lever includes a first rotation arm provided with a first cooperation portion, a second rotation arm provided with a second cooperation portion, and a third rotation arm provided with a third cooperation portion. The first cooperation portion, the second cooperation portion, and the third cooperation portion are sequentially arranged about a rotational axis of the second lever in a first direction. The first door hook is configured to move in a door closing direction to abut with the first cooperation portion and drive the second lever to rotate in the first direction, to allow the third cooperation portion to trigger the second microswitch after the first microswitch is triggered by the second cooperation portion.

According to the interlock device of the microwave oven of the embodiment of the present disclosure, the first cooperation portion, the second cooperation portion, and the third cooperation portion are sequentially arranged about the rotational axis of the second lever in the first direction. The second cooperation portion and the third cooperation portion are capable of sequentially triggering corresponding microswitches after the first cooperation portion is driven by the first door hook, which ensures orderliness of triggering the microswitches, avoiding the problem of disorder of the trigger sequence. Therefore, an effective detection of an open state or a closed state of the microwave oven can be realized. In addition, an arm length of the rotation arm can be effectively reduced while ensuring the trigger sequence, in such a manner that a small space is occupied, which realizes a compact structure of the interlock device. Therefore, the interlock device of the present disclosure can be applied to a microwave oven having a small volume and has strong versatility, which can effectively reduce manufacturing costs.

In addition, the interlock device according to the above embodiments of the present disclosure can further have the following additional features.

According to some embodiments of the present disclosure, the interlock support has a mounting space. The first cooperation portion extends into the mounting space, and the first door hook is configured to extend into the mounting space. A side wall of the mounting space has an avoidance recess, and the first rotation arm is located at the avoidance recess.

According to some embodiments of the present disclosure, the interlock support includes a first shield plate partially shielding a communication opening where the avoidance recess is in communication with the mounting space.

According to some embodiments of the present disclosure, the interlock support has a mounting space, and the second rotation arm is located in the mounting space. A second shield plate is provided in the mounting space, and a part of the second shield plate is at least located at a side of the second rotation arm close to the first door hook.

According to some embodiments of the present disclosure, the part of the second shield plate extends in the door closing direction and is located between the rotational axis of the second lever and the first door hook.

According to some embodiments of the present disclosure, the interlock support has a mounting space, and the third rotation arm is located in the mounting space. A third shield plate is provided in the mounting space and is located at a side of the third rotation arm close to the first door hook.

According to some embodiments of the present disclosure, an angle formed between the first cooperation portion and the second cooperation portion with respect to an axis of the second lever is α. An angle formed between the second cooperation portion and the third cooperation portion with respect to the axis of the second lever is β, where α<β.

According to some embodiments of the present disclosure, a spacing between the first cooperation portion and an axis of the second lever is greater than or equal to a spacing between the second cooperation portion and the axis of the second lever, and is greater than or equal to a spacing between the third cooperation portion and the axis of the second lever.

According to some embodiments of the present disclosure, the interlock device further includes: a monitoring switch provided at the interlock support; and a first lever rotatably provided at the interlock support. The first door hook is further configured to drive, before driving the second lever to rotate, the first lever to rotate in a second direction to trigger the monitoring switch.

According to some embodiments of the present disclosure, the first lever includes: a first drive arm provided with a first drive portion configured to trigger the monitoring switch; and a second drive arm located at a side of the first drive arm close to the first door hook. The first door hook is further configured to abut with the first drive arm to drive the first lever to rotate. The first cooperation portion is configured to be positioned between the first drive arm and the second drive arm in a door closed state.

According to some embodiments of the present disclosure, in an axial direction of the first lever, the second drive arm has a thinned region located at least one surface of the second drive arm; and/or an end of the first door hook has a thickness gradually decreasing in the door closing direction.

According to some embodiments of the present disclosure, in the axial direction of the first lever, the first drive arm is spaced apart from the first cooperation portion by a predetermined gap.

According to some embodiments of the present disclosure, the interlock device further includes an elastic member connected to the interlock support and the first lever. The elastic member has a first drive state in which the first lever is driven by the elastic member to rotate in the second direction and a second drive state in which the first lever is driven by the elastic member to rotate in the first direction. The first door hook is further configured to abut with the first lever during the door closing of the microwave oven to switch the elastic member into the first drive state from the second drive state.

According to some embodiments of the present disclosure, the interlock support is provided with a first limit portion and a second limit portion. The first limit portion is configured to abut with the first lever for limiting in a door closed state. The second limit portion is configured to abut with the first lever for limiting in a door opened state.

According to some embodiments of the present disclosure, the interlock device further includes a door closing buffer assembly connected to the interlock support and the first lever. The door closing buffer assembly is configured to apply a buffer force to the first lever in a direction opposite to the second direction during the door closing of the microwave oven.

According to some embodiments of the present disclosure, the door closing buffer assembly includes: a buffer member having an end rotatably connected to the interlock support; and a connector rotatably mounted at the first drive arm by a predetermined angle relative to a drive surface of the first lever. Another end of the buffer member is rotatably connected to the connector. The drive surface is capable of abutting with the connector after the first lever rotates by the predetermined angle in the second direction during the door closing of the microwave oven, to drive the connector to rotate.

According to some embodiments of the present disclosure, in an axial direction of the first lever, the connector has an avoidance notch formed at a side surface of the connector. The avoidance notch is configured to avoid the first cooperation portion.

According to one embodiment of the present disclosure, the microwave oven includes: a machine body; a door body mounted at the machine body; and the interlock device according to the embodiments of the present disclosure. The first door hook is mounted at the door body. The interlock support is mounted at the machine body.

One embodiment of the present disclosure provides a microwave oven.

According to one embodiment of the present disclosure, the microwave oven includes a door body, an interlock support, and a damping assembly. The door body has a first door hook and a second door hook. The interlock support is movably connected to the door body and fixedly provided with a first switch, a second switch, and a third switch. The damping assembly is mounted at the interlock support and includes a damper and a drive lever. The drive lever is rotatably connected to the interlock support and the damper. The microwave oven is configured and during closing of the door body, the first door hook directly abuts with the first switch to trigger the first switch, the second door hook directly abuts with the second switch to trigger the second switch, and the first door hook triggers the third switch through the drive lever.

In the above microwave oven, the first door hook directly abuts with the first switch to trigger the first switch, and the second door hook directly abuts with the second switch to trigger the second switch. In this way, the first switch, the second switch, and the third switch can be ensured to be triggered sequentially, which avoids the problem of disorder of the trigger sequence of the switches.

In some embodiments, the second door hook and/or the first door hook are fixed to the door body.

In some embodiments, the damping assembly further includes a swing block rotatably connected to the drive lever and the damper.

In some embodiments, the drive lever has an accommodation groove, and the accommodation groove has a rotation space formed at a top of the accommodation groove and a swing space formed at a bottom of the accommodation groove. The swing block has an end rotatably accommodated in the rotation space and another end accommodated in the swing space. The swing space is configured to provide a space for the drive lever to rotate relative to the swing block.

In some embodiments, the damping assembly includes an elastic member. The elastic member and the drive lever are located at two opposite sides of the interlock support. The interlock support has a third through hole, and the drive lever is connected to the elastic member through the third through hole. The elastic member is configured to drive the drive lever to accelerate rotation to allow the drive lever to drive the door body to accelerate.

In some embodiments, when the first door hook is separated from the drive lever, a direction in which the elastic member exerts a force to the drive lever is directed to above a connecting line between a connection of the elastic member with the drive lever and a rotational axis of the drive lever. When the first door hook exerts a force to the drive lever, a direction in which the elastic member exerts a force to the drive lever is directed to below a connecting line between a connection of the elastic member with the drive lever and the rotational axis of the drive lever.

In some embodiments, the elastic member includes a first elastic member and a second elastic member. The drive lever is provided with a connection structure. Each of the first elastic member and the second elastic member is connected to the connection structure, and an acute angle is formed between the first elastic member and the second elastic member.

In some embodiments, a protection block is movably mounted at the interlock support. The protection block is configured to: limit the drive lever when the first door hook is separated from the drive lever; and be driven by the first door hook to move during the closing of the door body, to release the limit of the protection block on the drive lever.

In some embodiments, the microwave oven further includes an inclined block and a third elastic member that are mounted at the interlock support. The third elastic member abuts with a bottom of the inclined block. The inclined block has an inclined guide surface at a top of the inclined block. The inclined guide surface is inclined upwardly towards an interior of the interlock support in a vertical direction. The inclined guide surface is capable of abutting with an end of the second door hook during the closing of the door body, to lower the inclined block to compress the third elastic member. The inclined block is capable of catching the second door hook through the third elastic element when the end of the second door hook moves across the inclined guide surface.

In some embodiments, the microwave oven further includes a cavity. The door body is rotatably connected at a side of the cavity. The interlock support is mounted in the cavity.

Additional embodiments of the present disclosure will be provided at least in part in the following description, or will become apparent at least in part from the following description, or can be learned from practicing of the present disclosure.

### BRIEF DESCRIPTION OF THE DRAWINGS

The above and/or additional embodiments of the present disclosure will become more apparent and more understandable from the following description of embodiments taken in conjunction with the accompanying drawings, in which:

FIG. 1 and FIG. 2 each are a schematic view showing a partial structure of a microwave oven according to an embodiment of the present disclosure, in which a door body is in an open state;

FIG. 3 is a schematic view showing a partial structure of FIG. 1, in which a cover body is not illustrated;

FIG. 4 is a schematic enlarged view showing a partial structure of FIG. 3;

FIG. 5 is a left view of FIG. 4;

FIG. 6 and FIG. 7 each are a right view showing a partial structure of a microwave oven according to an embodiment of the present disclosure, in which a door body is in a closed state;

FIG. 8 is a schematic view showing a partial structure of FIG. 6, in which a cover body is not illustrated;

FIG. 9 is a schematic enlarged view showing a partial structure of FIG. 8;

FIG. 10 is a left view of FIG. 9;

FIG. 11 is a schematic view showing a structure of a cover body, a first microswitch, and a second microswitch according to an embodiment of the present disclosure;

FIG. 12 and FIG. 13 each are a schematic view showing a structure of an interlock support and a second lever according to an embodiment of the present disclosure;

FIG. 14 to FIG. 16 each are a schematic view showing a structure of a first lever according to an embodiment of the present disclosure;

FIG. 17 and FIG. 18 each are a schematic view showing a structure of a second lever according to an embodiment of the present disclosure;

FIG. 19 and FIG. 20 each are a right view showing a partial structure of a microwave oven according to an embodiment of the present disclosure, in which a door body is in a closed state;

FIG. 21 is a schematic view showing a partial structure of FIG. 19, in which a cover body is not illustrated;

FIG. 22 is a schematic enlarged view showing a structure of circled part A in FIG. 21;

FIG. 23 to FIG. 25 each are a schematic view showing a partial structure of a microwave oven according to an embodiment of the present disclosure, in which a door body is in an open state;

FIG. 26 is a schematic view showing a partial structure of FIG. 24, in which a cover body is not illustrated;

FIG. 27 is a schematic enlarged view showing a structure of circled part B in FIG. 26;

FIG. 28 is a right view of showing a partial structure of a microwave oven according to an embodiment of the present disclosure, in which a first door hook is just in contact with a first lever;

FIG. 29 is a schematic view showing a partial structure of FIG. 28, in which a cover body is not illustrated;

FIG. 30 is a right view of showing a partial structure of a microwave oven according to an embodiment of the present disclosure, in which a monitoring switch is triggered by a first drive portion;

FIG. 31 is a right view of showing a partial structure of a microwave oven according to an embodiment of the present disclosure, in which a first door hook continues to move towards a door closing direction after a monitoring switch is triggered by a first drive portion;

FIG. 32 is a right view showing a partial structure of a microwave oven according to an embodiment of the present disclosure, in which a first door hook just triggers a second lever;

FIG. 33 is a right view showing a partial structure of a microwave oven according to an embodiment of the present disclosure, in which a first door hook moves towards a door opening direction;

FIG. 34 is a right view showing a partial structure of a microwave oven according to an embodiment of the present disclosure, in which an interlock device is abnormally triggered;

FIG. 35 and FIG. 36 each are a schematic view showing a structure of a support body and a second lever according to an embodiment of the present disclosure;

FIG. 37 and FIG. 38 each are a schematic view showing a structure of a driver, an inclined block, and a support body according to an embodiment of the present disclosure;

FIG. 39 and FIG. 40 each are a schematic view showing a structure of a first lever, a connector, a buffer member, and a support body according to an embodiment of the present disclosure;

FIG. 41 and FIG. 42 each are a schematic view showing a structure of a door body, a first door hook, and a second door hook according to an embodiment of the present disclosure;

FIG. 43 and FIG. 44 each are a schematic view showing a structure of a cover body according to an embodiment of the present disclosure;

FIG. 45 and FIG. 46 each are a schematic view showing a structure of a support body according to an embodiment of the present disclosure;

FIG. 47 is a sectional view taken along line C-C in FIG. 46;

FIG. 48 is a left view of FIG. 45;

FIG. 49 and FIG. 50 each are a schematic view showing a structure of a drive link according to an embodiment of the present disclosure;

FIG. 51 is a sectional view taken along line D-D in FIG. 50;

FIG. 52 and FIG. 53 each are a schematic view showing a structure of a connector according to an embodiment of the present disclosure;

FIG. 54 and FIG. 55 each are a schematic view showing a structure of a second lever according to an embodiment of the present disclosure;

FIG. 56 is a schematic view showing a structure of an inclined block according to an embodiment of the present disclosure;

FIG. 57 and FIG. 58 each are a schematic view showing a structure of a first door hook and a second door hook according to an embodiment of the present disclosure;

FIG. 59 and FIG. 60 each are a schematic view showing a partial structure of a microwave oven according to an embodiment of the present disclosure;

FIG. 61 is a schematic enlarged view of part III in FIG. 60;

FIG. 62 to FIG. 68 each are a schematic view showing a partial structure of a microwave oven according to an embodiment of the present disclosure; and

FIG. 69 and FIG. 70 each are a schematic view showing a direction of a force exerted on a drive lever according to an embodiment of the present disclosure.

### REFERENCE NUMERALS OF THE ACCOMPANYING DRAWINGS

1000, microwave oven;
100, interlock device; 200, door body;
11, first door hook; 12, second door hook;
20, interlock support; 201, monitoring switch; 202, first microswitch; 203, second microswitch; 204, mounting space; 205, avoidance recess; 21, first limit portion; 22, support body; 221, third through hole; 222, first mounting post; 223, second mounting post; 23, cover body; 231, first through hole; 232, second through hole; 24, second limit portion; 25, first shield plate; 26, second shield plate; 27, third shield plate;
30, first lever; 31, first drive arm; 32, second drive arm; 33, first drive portion; 34, elastic member; 35, connection portion; 36, drive surface; 37, groove; 38, curved hook; 39, thinned region;
40, second lever; 41, first rotation arm; 42, second rotation arm; 43, third rotation arm; 44a, second drive portion; 44, second cooperation portion; 45, first cooperation portion; 46, third cooperation portion;
50, door closing buffer assembly; 51, buffer member; 52, connector; 521, avoidance notch; 53, driver; 54, inclined block;
124, accommodation groove; 21a, first switch; 22a, second switch; 23a, third switch; 24a, protection block; 30a, damping assembly; 301, first engagement region; 302, second engagement region; 31a, damper; 32a, drive lever; 321, accommodation groove; 322, rotation space; 323, swing space; 324, connection structure; 33a, swing block; 341, first elastic member; 342, second elastic member; 40a, inclined block; 50a, third elastic member.

### DETAILED DESCRIPTION OF THE DISCLOSURE

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the present disclosure, it should be understood that the orientation or position relationship indicated by the terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, and “circumferential” should be construed to refer to the orientation or the position as shown in the drawings, and is only for the convenience of describing the present disclosure and simplifying the description, rather than indicating or implying that the pointed apparatus or element must have a specific orientation, or be constructed and operated in a specific orientation, and therefore cannot be understood as a limitation of the present disclosure.

In the description of the present disclosure, “first feature” and “second feature” may include one or more such features, and “plurality” means two or more. The first feature “on” or “under” the second feature may mean that the first feature is in direct contact with the second feature, or that the first feature and the second feature are in indirect contact through another feature between them. In one embodiment, the first feature “above” the second feature means that the first feature is directly above and obliquely above the second feature, or simply means that the level of the first feature is higher than that of the second feature.

An interlock device 100 of a microwave oven 1000 according to one embodiment of the present disclosure and the microwave oven 1000 having the same are described below with reference to the accompanying drawings.

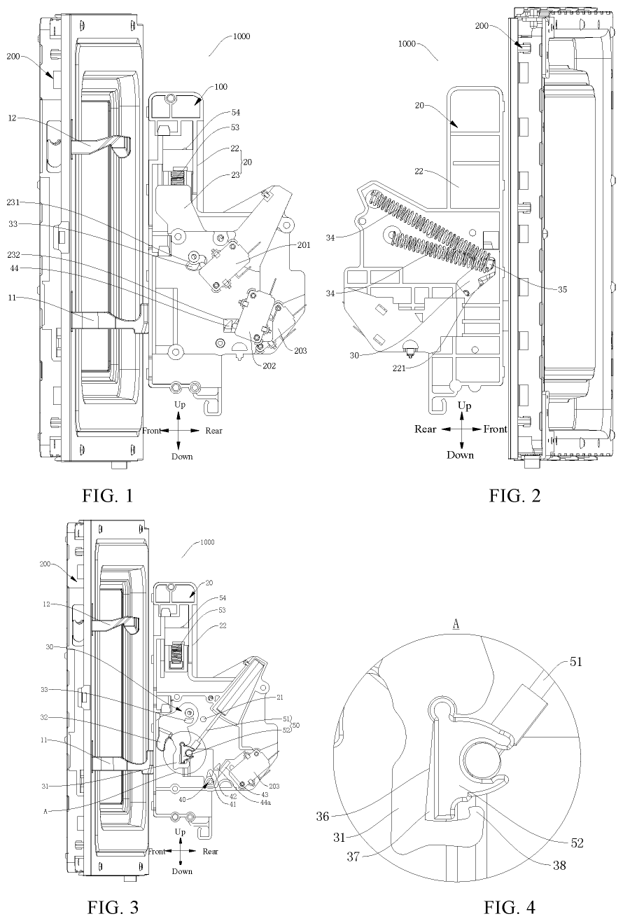

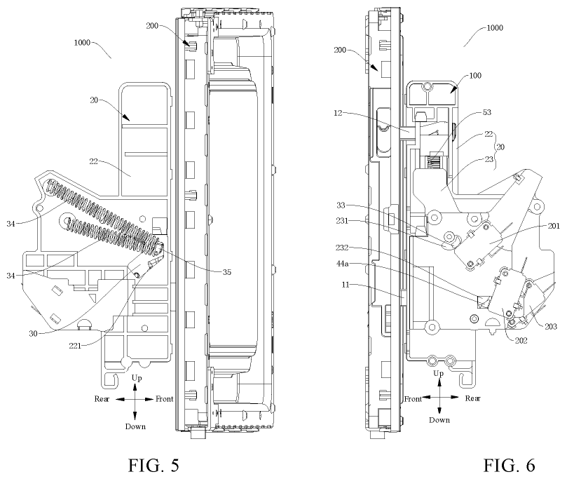

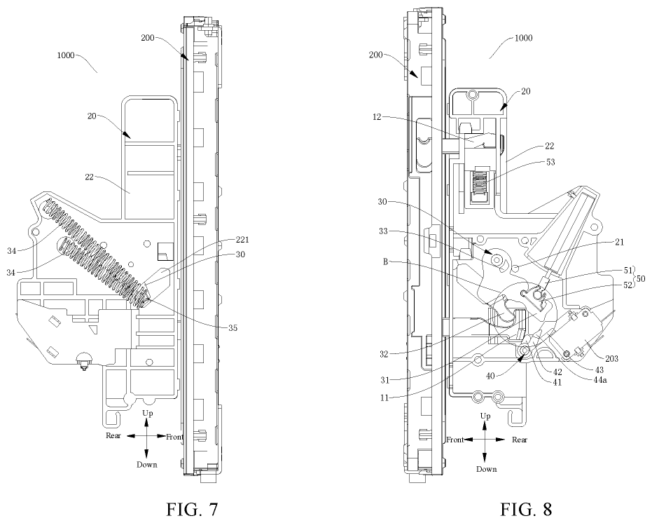

As illustrated in FIG. 1 to FIG. 10, according to one embodiment of the present disclosure, the microwave oven 1000 may include a machine body, a door body 200, and the interlock device 100 of the microwave oven 1000 according to the embodiments of the present disclosure. The door body 200 is mounted at the machine body. For example, the door body 200 is rotatably mounted at the machine body, to enable opening or closing of a holding cavity of the machine body, and to enable switching between an open state and a closed state of the door body 200. The interlock device 100 may implement corresponding functions based on a state switch of the door body 200.

The interlock device 100 of the microwave oven 1000 according to the embodiments of the present disclosure may include a first door hook 11, an interlock support 20, a first lever 30, and a second lever 40.

In an exemplary embodiment of the present disclosure, the first door hook 11 may be mounted at the door body 200 to move relative to the machine body in response to a door opening or closing operation of the door body 200. The interlock support 20 is mounted at the machine body and the first door hook 11 is capable of cooperating with the interlock support 20 and members at the interlock support 20 during a movement of the first door hook 11 relative to the machine body.

In an exemplary embodiment of the present disclosure, the interlock support 20 is provided with three switches, namely a monitoring switch 201, a first microswitch 202, and a second microswitch 203. In another exemplary embodiment of the present disclosure, the monitoring switch may be a microswitch. When the monitoring switch 201, the first microswitch 202, and the second microswitch 203 are triggered sequentially, the door body 200 is determined to be closed, and thus the microwave oven 1000 can be powered on and operate normally.

In the related art, a microwave oven adopts a microswitch layout for controlling a primary microswitch by an upper door hook of a movable door hook and indirectly controlling a secondary microswitch and a monitoring microswitch by a lower door hook during door closing. However, in the above-described manner of triggering the microswitches, a trigger sequence of the microswitches is prone to disorder during the door closing of the microwave oven, resulting in a potential safety hazard or affecting the service life of the microwave oven.

In the embodiments of the present disclosure, as illustrated in FIG. 1 to FIG. 10, the first lever 30 is rotatably mounted at the interlock support 20, and the second lever 40 is rotatably mounted at the interlock support 20. The first door hook 11 is configured to move relative to the interlock support 20 and sequentially drive the first lever 30 and the second lever 40 to rotate during door closing of the microwave oven 1000, to allow the second lever 40 to sequentially trigger the first microswitch 202 and the second microswitch 203 after the monitoring switch 201 is triggered by the first lever 30.

Therefore, the monitoring switch 201, the first microswitch 202, and the second microswitch 203 are triggered sequentially through driving of a same door hook (i.e., through driving of the first door hook 11) and orderly transmission of two levers (i.e., the first lever 30 and the second lever 40), to avoid a problem of disorder of a trigger sequence of multiple switches. Therefore, both an open state and a closed state of a door body 200 can be ensured to be detected accurately. In addition, damages to a circuit of the microwave oven 1000 or even safety accidents can be avoided, which is conducive to improving the service life of the microwave oven 1000.

For example, the door body 200 is rotatably mounted at the machine body about a rotational axis extending in a vertical direction. During the door closing of the microwave oven 1000, the door body 200 is rotated to allow the first door hook 11 to move rearwards relative to the interlock support 20 substantially in a front-rear direction illustrated in FIG. 1. In a movement process, the first door hook 11 is first brought into contact with the first lever 30 at the interlock support 20 and drives the first lever 30 to rotate in a first direction (a counterclockwise direction illustrated in FIG. 1). When the first lever 30 rotates by a predetermined angle, the first lever 30 triggers the monitoring switch 201. Then, the first door hook 11 is in contact with the second lever 40 and drives the second lever 40 to rotate in a second direction (a clockwise direction illustrated in FIG. 1). When the second lever 40 rotates by a first predetermined angle, the first microswitch 202 is triggered. When the second lever 40 continues to rotate until a second predetermined angle is reached, the second microswitch 203 is triggered. Thus, the monitoring switch 201, the first microswitch 202, and the second microswitch 203 are sequentially and orderly triggered.

It should be noted that, in an entire rotation process of the first lever 30 and the second lever 40, the first lever 30 and the second lever 40 may rotate completely under the driving of the first door hook 11, or the first lever 30 and the second lever 40 may be provided with an initial force by the first door hook 11 to start the rotation and then rotate under driving of other structures. All of these implementations are within the protection scope of the present disclosure.

In addition, in some embodiments, the door body 200 of the microwave oven 1000 may further include a second door hook 12. For example, as illustrated in FIG. 1 to FIG. 10, the first door hook 11 is a lower door hook, and the second door hook 12 is an upper door hook. The lower door hook is disposed below the upper door hook. In other embodiments of the present disclosure, the door body 200 may further include a third door hook, or more door hooks, or the like. The door hooks is in a vertical direction arranged at intervals. In an embodiment where the door hooks are provided, the first door hook 11 is configured to cooperate with two levers to indirectly trigger the three switches, ensuring that the three switches are switched on or off orderly.

The first door hook 11 may be a fixed door hook, i.e., fixed with respect to the door body 200, to allow the first door hook 11 to be stable in position and structure in a process of driving the first lever 30 and the second lever 40 to rotate. In this way, orderly triggering for the microswitches can be prevented from being affected by a change in a position of the first door hook 11. Other door hooks such as the second door hook 12 and the third door hook may be fixed door hooks or movable door hooks. For example, the other door hooks may be rotatably or movably mounted at the door body 200.

According to the interlock device 100 of the microwave oven 1000 of the embodiment of the present disclosure, the monitoring switch 201, the first microswitch 202, and the second microswitch 203 are triggered sequentially through the driving of the first door hook 11 and orderly transmission of the first lever 30 and the second lever 40, to avoid the problem of disorder of the trigger sequence of the switches. Therefore, both the open state and the closed state of the door body 200 can be ensured to be detected accurately. In addition, damages to the circuit of the microwave oven 1000 or even safety accidents can be avoided, which is conducive to improving the service life of the microwave oven 1000.

Since the interlock device 100 of the microwave oven 1000 according to the embodiments of the present disclosure provides the above advantageous effects, the microwave oven 1000 according to the embodiments of the present disclosure enables the monitoring switch 201, the first microswitch 202, and the second microswitch 203 to be triggered sequentially through the driving of the first door hook 11 and orderly transmission of the first lever 30 and the second lever 40, which avoids the problem of disorder of the trigger sequence of the switches. Therefore, both the open state and the closed state of the door body 200 can be ensured to be detected accurately. In addition, damages to the circuit of the microwave oven 1000 or even safety accidents can be avoided, which is conducive to improving the service life of the microwave oven 1000.

According to some embodiments of the present disclosure, as illustrated in FIG. 1 to FIG. 10, a rotational axis of the first lever 30 is located at a side of a rotation axis of the second lever 40 close to the first door hook 11. For example, as illustrated in FIG. 3 and FIG. 8, the rotational axis of the first lever 30 is disposed at a front side of the rotational axis of the second lever 40, and the first door hook 11 is disposed at a front side of the rotational axis of the first lever 30. In this way, the first door hook 11 moves backwards during the door closing of the microwave oven 1000. Therefore, the first door hook 11 can be in contact with the first lever 30, and then in contact with the second lever 40, which avoids a triggering disorder of the switches.

According to some embodiments of the present disclosure, as illustrated in FIG. 1 to FIG. 10, the rotational axis of the first lever 30 and the rotational axis of the second lever 40 are located at two sides of the first door hook 11 perpendicular to a door closing direction, respectively. For example, as illustrated in FIG. 3 and FIG. 8, the rotational axis of the first lever 30 is located at an upper side of the first door hook 11, and the rotational axis of the second lever 40 is located at a lower side of the first door hook 11. The above arrangement can prevent an arrangement and rotations of the first lever 30 and the second lever 40 from interfering with each other. Further, the arrangement of the first lever 30 and the second lever 40 in the door closing direction (such as in the front-rear direction) is compact, and thus the first door hook 11 can be in contact with the first lever 30 and the second lever 40 for transmission without being too long. In this way, the interlock device 100 has a compact structure.

A specific structure of the first lever 30 according to some embodiments of the present disclosure is described below with reference to the accompanying drawings.

In some embodiments of the present disclosure, as illustrated in FIG. 14 to FIG. 16, the first lever 30 may include a first drive arm 31 provided with a first drive portion 33 configured to trigger the monitoring switch 201. As illustrated in FIG. 6 to FIG. 10, the first door hook 11 is further configured to abut with the first drive arm 31 during the door closing of the microwave oven 1000 to drive the first drive arm 31 to rotate around the rotational axis of the first lever 30 in the first direction. Therefore, the first drive portion 33 may be driven to rotate. In this way, the first drive portion 33 may rotate to a position triggering the monitoring switch 201 to switch on the monitoring switch 201.

It should be noted that a position of the first drive portion 33 at the first drive arm 31 may be flexibly arranged based on actual conditions such as a spatial arrangement. For example, the first drive portion 33 may be provided at any position such as a middle or an end of the first drive arm 31 in a length direction of the first drive arm 31.

In some embodiments, the first drive portion 33 may be a protrusion disposed at a side of the first drive arm 31 in an axial direction. In this way, the first drive portion 33 is free from interference of the first drive arm 31 during cooperation with the monitoring switch 201, which avoids a risk of bringing the first drive arm 31 into contact with the monitoring switch 201 by mistake.

In some embodiments of the present disclosure, as illustrated in FIG. 14 to FIG. 16, the first lever 30 may further include a second drive arm 32 located at a side of the first drive arm 31 close to the first door hook 11. That is, the first drive arm 31 is located at a leading side of the second drive arm 32 in the first direction.

The first door hook 11 is further configured to extend to a position between the first drive arm 31 and the second drive arm 32 during the door closing of the microwave oven 1000, enabling the first door hook 11 to abut with the first drive arm 31 and drive the first lever 30 to start rotating in the first direction. The first door hook 11 is further configured to abut with the second drive arm 32 during door opening of the microwave oven 1000 to drive the first lever 30 to rotate in a second direction opposite to the first direction, enabling the first lever 30 to be separated from the monitoring switch 201. Therefore, the monitoring switch 201 can be switched off.

In this way, the first door hook 11 is capable of driving the first lever 30 to rotate in two directions to trigger the monitoring switch 201 or restore a position of the monitoring switch 201, which is beneficial to simplifying the structure of the interlock device 100. In other embodiments of the present disclosure, a structure for driving a position of the first lever 30 to be restored includes, but is not limited to, the second drive arm 32 cooperating with the first door hook 11. For example, in other embodiments, a restoring member such as a spring may be further provided to drive the first lever 30 to rotate in the second direction for restoring the position of the first lever 30 after the first door hook 11 moves in a door opening direction.

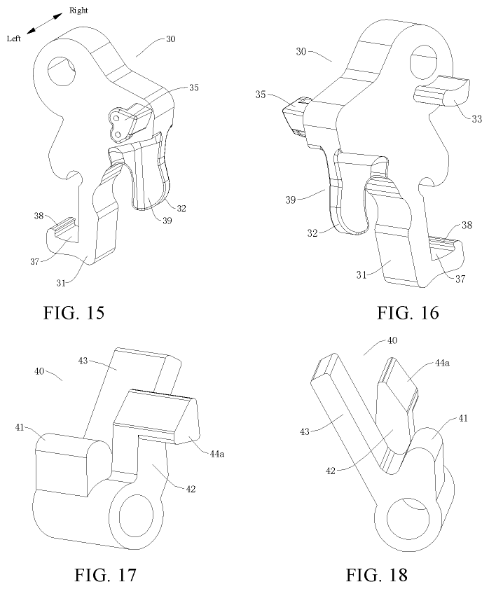

According to some embodiments of the present disclosure, as illustrated in FIG. 1 to FIG. 10, the interlock device 100 may further include an elastic member 34 connected to the interlock support 20 and the first lever 30. For example, the elastic member 34 may be a coil spring. One or a plurality of coil springs may be provided. In examples illustrated in FIG. 1 to FIG. 10, two elastic members 34 are provided and each are a tension spring. As illustrated in FIG. 15 and FIG. 16, the first lever 30 is provided with a connection portion 35. The connection portion 35 is a protrusion provided at a side surface of the first lever 30 facing away from the first drive portion 33. Each tension spring has an end connected to the interlock support 20 and another end connected to the connection portion 35. The two tension springs are spaced apart from each other at one end by a predetermined distance.

Further, the elastic member 34 has a first drive state. The elastic member 34 is configured to apply a drive force for rotating the first lever 30 in the first direction to the first lever 30 in the first drive state to allow the second drive arm 32 to drive the first door hook 11 to move in a door closing direction.

In an exemplary embodiment of the present disclosure, as illustrated in FIG. 6 to FIG. 10, the first door hook 11 is configured to move in the door closing direction to the position between the first drive arm 31 and the second drive arm 32 and abut with first drive arm 31 during the door closing of the microwave oven 1000, to drive the first lever 30 to start rotating in the first direction. When the first lever 30 starts to rotate in the first direction or rotates by a small angle, the elastic member 34 is in the first drive state to automatically drive the first lever 30 to rotate in the first direction. In this way, the first door hook 11 is driven by the second drive arm 32 to continue to move in the door closing direction, in such a manner that an automatic door closing function is realized. In this case, even if a user cancels a force exerted on the door body 200 for closing the door body 200, the door body 200 can still be ensured to be closed properly, and thus the first door hook 11 can be ensured to move in the door closing direction until all three switches are triggered. On the one hand, the user can operate the door body 200 with less effort and more convenience. On the other hand, a problem of failing to close the door properly can be avoided.

In some embodiments, as illustrated in FIG. 1 to FIG. 5, the elastic member 34 has a second drive state. The elastic member 34 is further configured to apply a drive force for rotating the first lever 30 in the second direction to the first lever 30 in the second drive state. The first door hook 11 is further configured to abut with the first drive arm 31 during the door closing of the microwave oven 1000 to switch the elastic member 34 from the second drive state into the first drive state.

In an exemplary embodiment of the present disclosure, in a door opened state, the first lever 30 may be maintained at a desired position by the elastic member 34. On the one hand, the first lever 30 can be prevented from rotating in the first direction without being acted upon by the first door hook 11, avoiding mistakenly triggering the monitoring switch 201. On the other hand, the first door hook 11 can be ensured to move smoothly to the position between the first drive arm 31 and the second drive arm 32 during the door closing of the microwave oven 1000 to prevent the first lever 30 from rotating and affecting cooperation between the first door hook 11 and the first lever 30. In addition, the first door hook 11 and the first drive arm 31 abut with each other to drive the first lever 30 to rotate in the first direction, which enables the elastic member 34 to switch the drive state in time along with the rotation of the first lever 30, and ensures that the elastic member 34 can drive the door to close in time.

In a door closed state, the elastic member 34 is in the first drive state to allow the first lever 30 to abut with the first door hook 11 through the second drive arm 32, ensuring that the door body 200 remains in the closed state. When the door needs to be opened, the first door hook 11 is controlled by the user to move in the door opening direction and to abut with the second drive arm 32, enabling the first lever 30 to rotate in the second direction. When the first lever 30 rotates by a predetermined angle, the elastic member 34 is switched from the first drive state into the second drive state, which allows the elastic member 34 to drive the first lever 30 to rotate in the second direction to release a resistance on the first door hook 11 in time. Thus, the door body 200 can be opened easily.

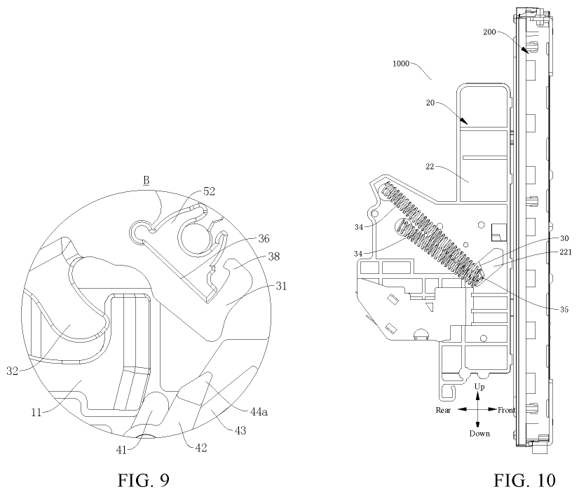

In some embodiments of the present disclosure, as illustrated in FIG. 9 and FIG. 14 to FIG. 16, the second drive arm 32 may have a length smaller than a length of the first drive arm 31. Therefore, the first door hook 11 may be easily moved to the position between the first drive arm 31 and the second drive arm 32 during the door closing of the microwave oven 1000, which prevents the second drive arm 32 from interfering with a movement of the first door hook 11.

In some embodiments of the present disclosure, as illustrated in FIG. 9 and FIG. 14 to FIG. 16, in an axial direction of the first lever 30, the second drive arm 32 has a thickness smaller than a thickness of the first drive arm 31. A thickness difference causes a gap between the second drive arm 32 and the interlock support 20 to be greater than a gap between the first drive arm 31 and the interlock support 20. During the door closing of the microwave oven 1000, even if the second drive arm 32 interferes with the movement of the first door hook 11 in the door closing direction, the second drive arm 32 or the first door hook 11 is likely to be deformed to move the first door hook 11 to the position between the first drive arm 31 and the second drive arm 32. The first door hook 11 and the first drive arm 31 are less likely to be deformed, which causes the first door hook 11 to move to a side of the first drive arm 31 away from the second drive arm 32, ensuring stability of the cooperation between the first door hook 11 and the first lever 30.

In some specific embodiments, as illustrated in FIG. 15 and FIG. 16, in the axial direction of the first lever 30, the second drive arm 32 has a thinned region 39 located at a surface of the second drive arm 32. Therefore, when the first lever 30 is mounted at the interlock support 20, a predetermined gap can be formed between the thinned region 39 of the second drive arm 32 and the interlock support 20. When the first lever 30 is rotated in the first direction to a position triggering the monitoring switch 201 due to being triggered by mistake, the first door hook 11 may forcibly pass through the gap and move to the position between the first drive arm 31 and the second drive arm 32 through closing the door. Then through opening the door, the first door hook 11 may drive the first lever 30 to rotate in the second direction for restoring the position of the first lever 30.

For example, as illustrated in FIG. 15 and FIG. 16, the interlock support 20 includes a support body 22 and a cover body 23. The first lever 30 is mounted between the support body 22 and the cover body 23. The thinned region 39 may be a notch groove formed at a side of the second drive arm 32 facing towards the support body 22, which enables the gap to be formed between the second drive arm 32 and the support body 22.

In addition, the first door hook 11 may have a thickness gradually decreasing in the door closing direction. Thus, a rear end of the first door hook 11 has a smaller thickness, while a front end of the first door hook 11 has a greater thickness, as illustrated in FIG. 1. When the first lever 30 triggers the monitoring switch 201 by mistake, the structure of thick front end and thin rear end of the first door hook 11 enables the first door hook 11 to be moved from the thinned region 39 to the position between the first drive arm 31 and the second drive arm 32 easily. Therefore, an abnormal triggering problem can be solved easily.

According to some embodiments of the present disclosure, as illustrated in FIG. 3 and FIG. 8, the interlock support 20 may be provided with a first limit portion 21. The first limit portion 21 is configured to abut with the first lever 30 in a door closed state to block the first lever 30 from rotating in the first direction. In other words, the first limit portion 21 may limit a limit position the first lever 30 is rotated to in the first direction, to avoid damages to the monitoring switch 201 or the first door hook 11 caused by an excessive rotation angle of the first lever 30.

For example, in an embodiment where the elastic member 34 is provided, the elastic member 34 drives the first lever 30 to rotate in the first direction to drive the first door hook 11 to move in the door closing direction, realizing automatic door closing. When the first lever 30 abuts with the first limit portion 21, a limitation of the first limit portion 21 realizes a force balance of the first lever 30, and thus the first lever 30 is kept from rotating under driving of the elastic member 34. The first lever 30 can be maintained at a position that provides a stable engagement with the first door hook 11 and keeps the door body 200 closed.

According to some embodiments of the present disclosure, as illustrated in FIG. 3 and FIG. 8, the interlock device 100 may further include a door closing buffer assembly 50 connected to the interlock support 20 and the first lever 30. For example, the door closing buffer assembly 50 is connected to the first drive arm 31 of the first lever 30.

The door closing buffer assembly 50 is configured to apply a buffer force to the first lever 30 in a direction opposite to the first direction during the door closing of the microwave oven 1000. Therefore, a buffer action for the door closing of the microwave oven 1000 can be realized, which avoids a violent collision between the door body 200 and the machine body during the door closing of the microwave oven 1000, and also facilitates a noise reduction during the door closing of the microwave oven 1000.

A specific structure of the door closing buffer assembly 50 is not specifically limited in the present disclosure, as long as the structure can provide the buffer action for the door closing of the microwave oven 1000. For example, the door closing buffer assembly 50 may include a damper, a spring, a compression spring, or the like.

For example, in some embodiments, as illustrated in FIG. 3, FIG. 4, FIG. 8, and FIG. 9, the door closing buffer assembly 50 includes a buffer member 51 and a connector 52. The buffer member 51 has an end rotatably connected to the interlock support 20. The connector 52 is rotatably connected to another end of the buffer member 51 and the first drive arm 31, respectively. In this way, during the rotation of the first lever 30, the buffer member 51 serves as a buffer, while such a rotatable connection structure is adapted to the rotation of the first lever 30 to avoid jamming.

In addition, as illustrated in FIG. 3, FIG. 4, FIG. 8, and FIG. 9, the first drive arm 31 has a drive surface 36. The connector 52 is rotatably mounted at the first drive arm 31. Further, as illustrated in FIG. 4, the connector 52 forms a predetermined angle with the drive surface 36 in a door opened state. Another end of the buffer member 51 is rotatably connected to the connector 52. The drive surface 36 is capable of abutting with the connector 52 after the first lever 30 rotates in the first direction by the predetermined angle during the door closing of the microwave oven 1000, to drive the connector 52 to rotate.

Since the connector 52 is arranged at the predetermined angle to the drive surface 36 in the door opened state, when the first door hook 11 is just in contact with the first lever 30 and drives the first lever 30 to rotate in the first direction, the buffer member 51 is kept from applying a buffer force to the first lever 30, which enables the first door hook 11 to easily drive the first lever 30 to rotate.

In some specific embodiments, as illustrated in FIG. 3, FIG. 4, FIG. 8, and FIG. 9, a side of the first drive arm 31 facing towards the door closing buffer assembly 50 has a groove 37. A bottom wall surface of the groove 37 is formed as the drive surface 36. One side surface of the groove 37 is connected to a hole shaft of the connector 52, while another side surface of the groove 37 is provided with a curved hook 38 spaced apart from the drive surface 36 by a predetermined distance. The buffer member 51 is a damper. The damper is connected to the hole shaft of the connector 52 through an opening of the groove 37. The interlock device 100 further includes the elastic member 34 connected to the first lever 30.

The elastic member 34 is configured to apply a drive force for rotating the first lever 30 in the second direction in the door opened state, which enables the first door hook 11 to be smoothly moved until abutting with the first drive arm 31. In this case, the connector 52 and the drive surface 36 form the predetermined angle to keep the damper from generating a buffer force. The first door hook 11 is in contact with the first drive arm 31 and is configured to drive the first lever 30 to rotate in the first direction during the door closing of the microwave oven 1000. Since the damper provides no buffer force, the first door hook 11 only needs to drive the first lever 30 against the drive force of the elastic member 34, and thus a small resistance is generated. When the first lever 30 rotates until the connector 52 abuts with the drive surface 36, a state of the elastic member 34 is switched into applying the drive force for rotating the first lever 30 in the first direction to actively drive the first lever 30 to rotate, the first door hook 11 to move, and the door body 200 to close. In this case, the damper generates a buffer force to reduce noises generated during the door closing of the microwave oven 1000. The first door hook 11 is configured to pull the first lever 30 to rotate in the second direction and the connector 52 is configured to rotate relative to the first drive arm 31 during the door opening of the microwave oven 1000. In this way, a predetermined angle is formed between the connector 52 and the drive surface 36, and the curved hook abuts with the connector 52 to prevent the angle from being too large and prevent the connector 52 from falling out of the groove 37, which ensure the connector 52 to be stably connected to the first lever 30.

For example, in other embodiments, the door closing buffer assembly 50 may include the buffer member 51. The buffer member 51 is an elastic sheet or a compression spring. The door closing buffer assembly 50 is formed as a buffer energy accumulation assembly. In an exemplary embodiment of the present disclosure, one end of the elastic sheet is connected to the interlock support 20, and the first lever 30 abuts with another end of the elastic sheet. The elastic sheet can be elastically deformed to accumulate energy.

The first lever 30 is configured to rotate in the first direction and compress the other end of the elastic sheet during the door closing of the microwave oven 1000, to increase a bending degree of the elastic sheet and accumulate energy, which achieves the buffer action and energy accumulation. During the door opening of the microwave oven 1000, the elastic sheet can release the accumulated energy to apply the drive force for rotating the first lever 30 in the second direction. Therefore, the first lever 30 can push the first door hook 11 and the door body 200 to move towards the door opening direction, which is conducive to the door opening of the microwave oven 1000. In the door closed state, a direction of the drive force exerted by the elastic sheet on the first lever 30 is directed towards a rotation center of the first lever 30 or near the rotation center of the first lever 30. In this case, no component force or only a small component force is provided by the elastic sheet in a rotation direction of the first lever 30, which ensures the door body 200 to be tightly closed.

The second lever 40 according to some embodiments of the present disclosure is described below in conjunction with the accompanying drawings.

In some embodiments of the present disclosure, as illustrated in FIG. 17 and FIG. 18, the second lever 40 includes a first rotation arm 41, a second rotation arm 42, and a third rotation arm 43. The first rotation arm 41, the second rotation arm 42, and the third rotation arm 43 are sequentially arranged in the second direction (a clockwise direction illustrated in FIG. 3). As illustrated in FIG. 1 to FIG. 10, the first door hook 11 is capable of abutting with the first rotation arm 41 during the door closing of the microwave oven 1000 to drive the second lever 40 to rotate in the second direction. Therefore, the second rotation arm 42 and the third rotation arm 43 are driven to rotate in the second direction. The second rotation arm 42 is capable of triggering the first microswitch 202. The third rotation arm 43 is capable of triggering the second microswitch 203. Therefore, two microswitches can be driven to be switched on sequentially by one lever.

In some embodiments, as illustrated in FIG. 17 and FIG. 18, at least two of the first rotation arm 41, the second rotation arm 42, and the third rotation arm 43 are offset from each other in an axial direction of the second lever 40. Therefore, an angle formed by the first rotation arm 41, the second rotation arm 42, and the third rotation arm 43 in the second direction is small, and position interference is less likely to occur, which is beneficial to make the structure of the interlock device 100 more compact in a movement direction of the first door hook 11.

For example, as illustrated in FIG. 17 and FIG. 18, in the axial direction of the second lever 40, the first rotation arm 41 and the third rotation arm 43 are located at a same position, while the second rotation arm 42 is offset from the first rotation arm 41 and the third rotation arm 43. In this way, the three rotation arms are distributed in two layers in the axial direction. Correspondingly, the first microswitch 202 and the second microswitch 203 can be arranged in two layers in the axial direction of the second lever 40. The first door hook 11 is capable of driving the second lever 40 from a side of the first rotation arm 41 facing away from the third rotation arm 43. Therefore, interference between the first door hook 11, the first microswitch 202, and the second microswitch 203 can be avoided.

In some embodiments, the second rotation arm 42 may be provided with a second drive portion 44a, which enables the second rotation arm 42 and the first microswitch 202 to be at least partially offset from each other in the axial direction to meet spatial arrangement requirements.

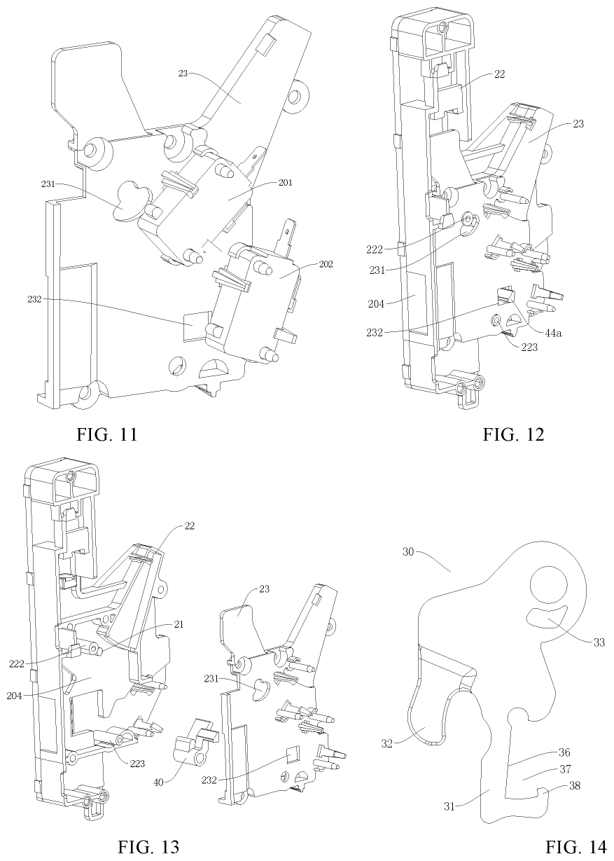

According to some embodiments of the present disclosure, as illustrated in FIG. 11 to FIG. 13, the interlock support 20 may include a support body 22 and a cover body 23. The cover body 23 covers the support body 22 to allow the cover body 23 to cooperate with the support body 22 to define a mounting space 204. The first lever 30 and the second lever 40 are mounted in the mounting space 204, for limiting positions of the first lever 30 and the second lever 40, which ensures that the two levers can rotate stably and are less likely to be interfered with or touched by other structures to prevent a normal operation from being affected.

As illustrated in FIG. 6 to FIG. 10, the first door hook 11 is capable of extending into the mounting space 204 during the door closing of the microwave oven 1000 to be in contact with the first lever 30 and the second lever 40. The mounting space 204 is further capable of shielding and protecting a cooperation structure between the first door hook 11 and the lever to ensure smooth driving. Furthermore, the mounting space 204 is further capable of guiding the first door hook 11, which ensures that the first door hook 11 can be accurately in contact with the first lever 30 and the second lever 40.

In some embodiments, as illustrated in FIG. 12 and FIG. 13, the support body 22 may be provided with a first mounting post 222 and a second mounting post 223. The first lever 30 is arranged around the first mounting post 222. The second lever 40 is arranged around the second mounting post 223. In addition, each of the first mounting post 222 and the second mounting post 223 has an end inserted into the cover body 23 to limit positions of the support body 22 and the cover body 23 through cooperation with the cover body 23, which prevents the cover body 23 and the support body 22 from being misaligned or deformed to avoid an influence on triggering for the switch.

In addition, in some embodiments, as illustrated in FIG. 1 to FIG. 5 and FIG. 11 to FIG. 13, the monitoring switch 201 is arranged at a side of the cover body 23 facing away from the support body 22. The cover body 23 has a first through hole 231. The first lever 30 is provided with a first drive portion 33. The first drive portion 33 is capable of passing through the first through hole 231 to extend to the side of the cover body 23 facing away from the support body 22. During the rotation of the first lever 30, the first drive portion 33 rotates in the first through hole 231 with the first lever 30 to facilitate triggering for the monitoring switch 201. The monitoring switch 201 may be disposed outside the mounting space 204 to avoid position interference with members in the mounting space 204, such as avoiding interference with the door closing buffer assembly 50, which enables the position arrangement to be reasonable.

As illustrated in FIG. 1 to FIG. 5 and FIG. 11 to FIG. 13, the first microswitch 202 is disposed at the side of the cover body 23 facing away from the support body 22, and the second microswitch 203 is arranged at the mounting space 204. The cover body 23 may further have a second through hole 232. The second lever 40 is provided with a second drive portion 44a. The second drive portion 44a is capable of passing through the second through hole 232 to extend to the side of the cover body 23 facing away from the support body 22. During the rotation of the second lever 40, the second drive portion 44a rotates in the second through hole 232 with the second lever 40 to facilitate triggering for the first microswitch 202 located outside the mounting space 204. A part of the second lever 40 located within mounting space 204 is capable of triggering the second microswitch 203 located within mounting space 204. The first microswitch 202 and the second microswitch 203 are located at different sides of the cover body 23, which prevents the first microswitch 202 and the second microswitch 203 from interfering with each other. For example, in the axial direction of the second lever 40, a projection of the first microswitch 202 may at least partially coincide with a projection of the second microswitch 203. In this way, an arrangement of the two microswitches can be more compact, and thus the first microswitch 202 and the second microswitch 203 can be sequentially triggered by the second lever 40 faster.

The microwave oven 1000 according to a specific embodiment of the present disclosure is described in detail below with reference to the accompanying drawings. It should be understood that the following description is illustrative only and should not be construed as a limitation of the present disclosure.

As illustrated in FIG. 1 to FIG. 18, the microwave oven 1000 according to the embodiment of the present disclosure includes the door body 200, the machine body, and the interlock device 100. The interlock device 100 includes the first door hook 11, the second door hook 12, the interlock support 20, the first lever 30, the second lever 40, the monitoring switch 201, the first microswitch 202, the second microswitch 203, the elastic member 34, the door closing buffer assembly 50, a driver 53, and an inclined block 54.

The door body 200 is rotatably mounted at the machine body around a vertical axis. The first door hook 11 and the second door hook 12 are fixedly mounted at the door body 200. Further, the second door hook 12 is located above the first door hook 11. The interlock support 20 is mounted at the machine body and includes the support body 22 and the cover body 23 to define the mounting space 204. The first lever 30 and the second lever 40 are rotatably mounted in the mounting space 204. The first lever 30 includes the first drive arm 31, the second drive arm 32, and the first drive portion 33. The first drive portion 33 passes through the first through hole 231 of the cover body 23. The second lever 40 includes the first rotation arm 41, the second rotation arm 42, the third rotation arm 43, and the second drive portion 44a passing through the second through hole 232 of the cover body 23. The second microswitch 203 is arranged in the mounting space 204. The monitoring switch 201 and the first microswitch 202 are arranged at the side of the cover body 23 facing away from the support body 22. The support body 22 has a third through hole 221. The elastic member 34 is arranged at a side of the support body 22 facing away from the cover body 23. The connection portion 35 of the first lever 30 passes through the third through hole 221 to be connected to the elastic member 34.

In addition, the inclined block 54 is movably mounted at the support body 22 in a vertical direction. Two ends of the driver 53 abut with the inclined block 54 and the support body 22, respectively, to apply an upward driving force to the inclined block 54.

As illustrated in FIG. 1 to FIG. 5, the first door hook 11 and the second door hook 12 are separated from the machine body in the door opened state. The driver 53 drives the inclined block 54 to a high position. The first lever 30 rotates in the clockwise direction to a limit position against an edge of the support body 22 under a pulling force of the elastic member 34 and is separated from the monitoring switch 20. The second lever 40 is at a position separated from the first microswitch 202 and the second microswitch 203.

During the door closing of the microwave oven 1000, the door body 200 is pushed to allow the first door hook 11 and the second door hook 12 to move in the door closing direction, i.e., to move backwards. The rear end of the first door hook 11 extends to the position between the first drive arm 31 and the second drive arm 32 and is configured to abut with the first drive arm 31 to push the first lever 30 to rotate in the counterclockwise direction. When the first lever 30 rotates by the predetermined angle, the pulling force of the elastic member 34 is switched to drive the first lever 30 to rotate in the counterclockwise direction, which allows the second drive arm 32 of the first lever 30 to automatically pull the first door hook 11 to move backwards. Further, the connector 52 is in contact with the drive surface 36. The drive surface 36 is configured to drive the connector 52 to move. The buffer member 51 provides the buffer action. The first lever 30 rotates to enable the first drive portion 33 to trigger the monitoring switch 201. Then, when moved until being brought into contact with the second lever 40, the first door hook 11 drives the second lever 40 to rotate in the clockwise direction. The first microswitch 202 and the second microswitch 203 are sequentially triggered by the second drive portion 44a and the third rotation arm 43 of the second lever 40. The second door hook 12 is configured to abut with the inclined block 54 during the door closing of the microwave oven 1000. The inclined block 54 is configured to compress the driver 53 to move a hook portion of the second door hook 12 to a rear side of the inclined block 54. In this way, a position of the second door hook 12 is limited by the inclined block 54 to keep the door body 200 closed.

As illustrated in FIG. 6 to FIG. 10, the first lever 30 is configured to stop rotating when rotated until abutting with the first limit portion 21, and the second lever 40 is configured to stop rotating after triggering the second microswitch 203. In this case, under the pulling force of the elastic member 34, the first door hook 11 is blocked by the second drive arm 32 of the first lever 30. Therefore, the door body 200 is kept in the door closed state, and the first lever 30 and the second lever 40 are kept in positions where the monitoring switch 201, the first microswitch 202, and the second microswitch 203 are enabled to be switched on.

The door body 200 is configured to rotate in reverse to be opened during the door opening of the microwave oven 1000 to allow the first door hook 11 to move forwards. In the movement process, a block force against the second lever 40 is first canceled. The second lever 40 is configured to rotate in the counterclockwise direction under a rebound force of the first microswitch 202 and a rebound force of the second microswitch 203 to cancel triggering for the first microswitch 202 and the second microswitch 203. Further, the first door hook 11 is configured to abut with the second drive arm 32 during the movement of the first door hook 11 to drive the first lever 30 against an elastic force of the elastic member 34 and to rotate in the clockwise direction. In this way, triggering for the monitoring switch 201 is released by the first drive portion 33. When the pulling force of the elastic member 34 is switched to drive the first lever 30 to rotate in the clockwise direction, the first lever 30 is automatically restored to the position against the edge of the support body 22 under the driving of the elastic member 34 and stays at the position. In addition, the first lever 30 is capable of driving the first door hook 11 to move forwards, which allows the door body 200 to be sprang open. The second door hook 12 is configured to abut with the inclined block 54 again during the door opening of the microwave oven 1000. The inclined block 54 is configured to compress the driver 53 to move the hook portion of the second door hook 12 to a front side of the inclined block 54, in such a manner that the limit exerted by the inclined block 54 on the second door hook 12 can be released for opening the door body 200.

In summary, the first door hook 11 cooperates with the two levers to trigger the three switches, respectively. The switches are in indirect contact with the first door hook 11. Further, the monitoring switch 201, the first microswitch 202, and the second microswitch 203 can be triggered sequentially, which ensures safety of the machine.

The interlock device 100 of the microwave oven 1000 according to one embodiment of the present disclosure and the microwave oven 1000 having the interlock device 100 are described below with reference to the accompanying drawings.

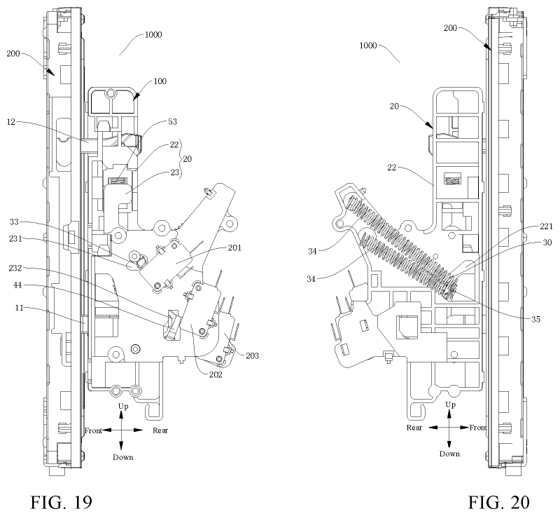

As illustrated in FIG. 19 to FIG. 58, the microwave oven 1000 according to the embodiment of the present disclosure may include a machine body, a door body 200, and the interlock device 100 of the microwave oven 1000 according to the embodiments of the present disclosure. The door body 200 is mounted at the machine body. For example, the door body 200 is rotatably mounted at the machine body to open or close a holding cavity of the machine body and switch between an open state and a closed state of the door body 200. The interlock device 100 can implement corresponding functions based on a state switch of the door body 200.

The interlock device 100 of the microwave oven 1000 according to the embodiments of the present disclosure may include the first door hook 11, the interlock support 20, and the second lever 40.

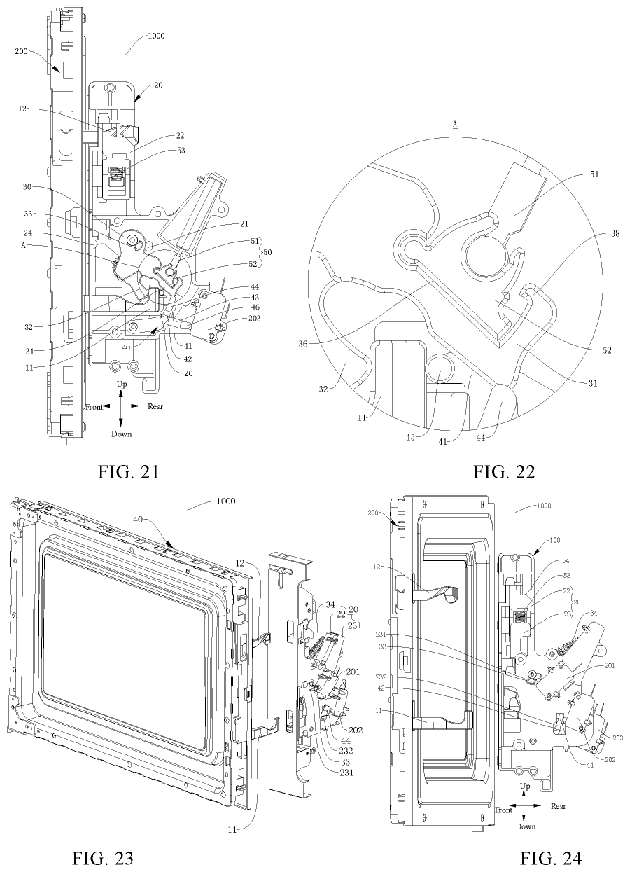

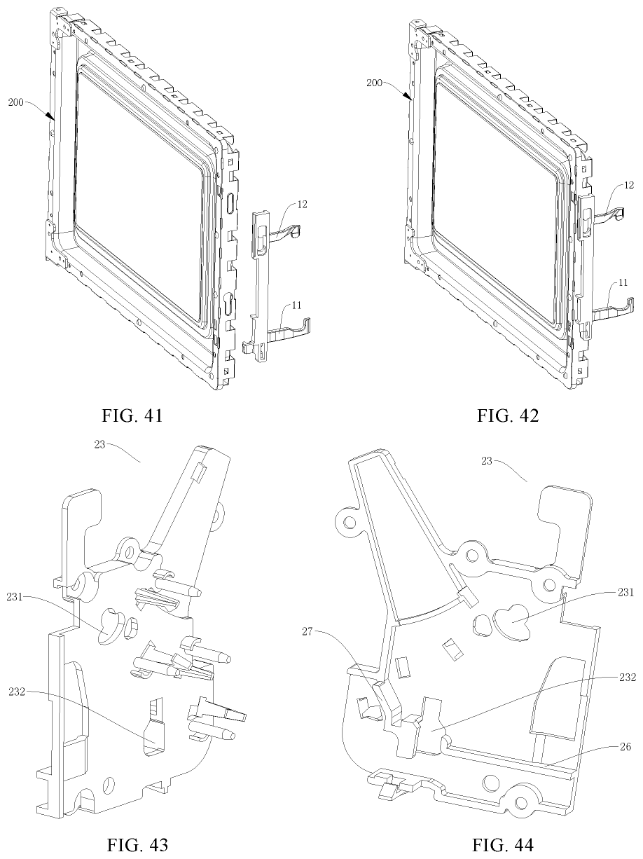

In an exemplary embodiment of the present disclosure, as illustrated in FIG. 21, FIG. 41, FIG. 42, FIG. 57, and FIG. 58, the first door hook 11 may be mounted at the door body 200 to move relative to the machine body in response to a door opening or closing operation of the door body 200. The interlock support 20 is mounted at the machine body and the first door hook 11 is capable of cooperating with the interlock support 20 and members at the interlock support 20 during a movement of the first door hook 11 relative to the machine body.

In an exemplary embodiment of the present disclosure, the interlock support 20 is provided with two switches, namely the first microswitch 202 and the second microswitch 203. The first microswitch 202 and the second microswitch 203 need to be triggered sequentially to ensure that the microwave oven 1000 can be powered on and operated normally.

In the related art, a split door hook is adopted for a design of slow door closing/soft door closing of a side pull microwave oven. A slow door closing process is realized by utilizing a buckle, a slideway, a spring, a damper, or the like. However, such a slow door closing system occupies a large space. To ensure that a sufficient space is reserved for other members, schemes with different size proportions need to be designed for models having different volumes, which has poor universality and produces high costs.

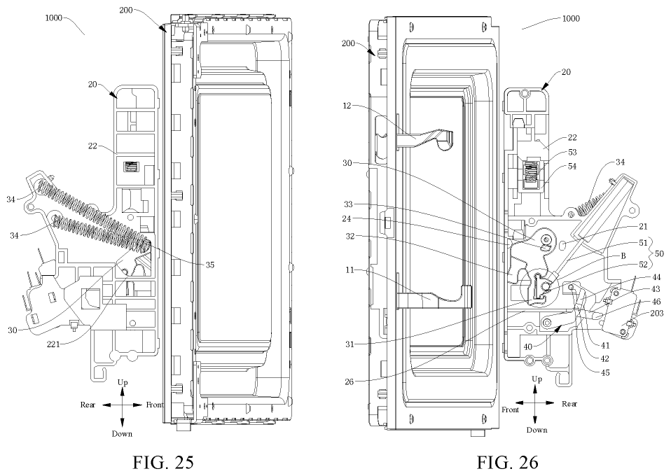

In the embodiments of the present disclosure, as illustrated in FIG. 21, FIG. 25, and FIG. 36, the second lever 40 is rotatably mounted at the interlock support 20. The second lever 40 may include the first rotation arm 41 provided with a first cooperation portion 45, the second rotation arm 42 provided with a second cooperation portion 44, and the third rotation arm 43 provided with a third cooperation portion 46. In addition, the first cooperation portion 45, the second cooperation portion 44, and the third cooperation portion 46 are sequentially arranged about the rotational axis of the second lever 40 in the first direction (a clockwise direction illustrated in FIG. 21). On the one hand, sequential triggering for the microswitches at the interlock support 20 can be facilitated to avoid the disorder of the trigger sequence. On the other hand, a reasonable arrangement of the microswitches at the interlock support 20 can be facilitated to realize a compact structure of the machine body of the microwave oven 1000.

During the door closing of the microwave oven 1000, as illustrated in FIG. 19 to FIG. 21, the first door hook 11 is configured to move in the door closing direction to abut with the first cooperation portion 45 and drive the second lever 40 to rotate in the first direction, which allows the third cooperation portion 46 to trigger the second microswitch 203 after the first microswitch 202 is triggered by the second cooperation portion 44. The first microswitch 202 and the second microswitch 203 can be sequentially triggered for detecting the open state or the closed state of the door body 200, which ensures that microwave oven 1000 can operate normally and avoids the disorder of the trigger sequence. Therefore, a potential safety hazards of the microwave oven 1000 due to the disorder of the trigger sequence of the microswitches is avoided.

It should be noted that each of the first microswitch 202 and the second microswitch 203 may be provided with an elastic sheet. The second cooperation portion 44 and the third cooperation portion 46 are configured to trigger the first microswitch 202 and the second microswitch 203 through the elastic sheets. To ensure the trigger sequence, the microswitches at the interlock support 20 should be arranged reasonably. An angle formed between the elastic sheet of the first microswitch 202 and the second cooperation portion 44 about the rotational axis should be smaller than an angle formed between the elastic sheet of the second microswitch 203 and the third cooperation portion 46 about the rotational axis.

For example, as illustrated in FIG. 19 to FIG. 22, the door body 200 is rotatably mounted at the machine body about a rotational axis extending in a vertical direction. During the door closing of the microwave oven 1000, the door body 200 is rotated to allow the first door hook 11 to move rearwards relative to the interlock support 20 substantially in a front-rear direction illustrated in FIG. 17. In a movement process, the first door hook 11 is first brought into contact with the first cooperation portion 45 and drives the second lever 40 to rotate in the first direction (a clockwise direction illustrated in FIG. 17). The second cooperation portion 44 and the third cooperation portion 46 rotate by the same angle in the first direction after the second lever 40 starts to rotate. With a reasonable arrangement of the first microswitch 202 and the second microswitch 203 at the interlock support 20, the second cooperation portion 44 may be in contact with the first microswitch 202 to trigger the first microswitch 202 when the second lever 40 rotates to the first predetermined angle. When the second lever 40 continues to rotate until the second predetermined angle is reached, the third cooperation portion 46 is in contact with the second microswitch 203 to trigger the second microswitch 203. Thus, the first microswitch 202 and the second microswitch 203 are orderly triggered.

Compared with the related art, in the present disclosure, the first cooperation portion 45, the second cooperation portion 44, and the third cooperation portion 46 are sequentially arranged in the first direction. That is, projections of the first cooperation portion 45, the second cooperation portion 44, and the third cooperation portion 46 in a cross-section perpendicular to an axis of the second lever 40 are offset from each other sequentially. In this way, the sequential triggering for the first microswitch 202 and the second microswitch 203 can be realized without increasing an arm length of each of the first rotation arm 41, the second rotation arm 42, and the third rotation arm 43. As a result, an occupied space is reduced, and the structure of the interlock device 100 is more compact while ensuring the sequential triggering for the microswitches. In addition, the interlock device 100 can be mounted in a microwave oven 1000 having a small volume, which provides good versatility and can effectively reduce manufacturing costs.

According to the interlock device 100 of the microwave oven 1000 of the embodiment of the present disclosure, the first cooperation portion 45, the second cooperation portion 44, and the third cooperation portion 46 are sequentially arranged about the rotational axis of the second lever 40 in the first direction. The second cooperation portion 44 and the third cooperation portion 46 are capable of sequentially triggering corresponding microswitches after the first cooperation portion 45 is driven by the first door hook 11, which ensures orderliness of triggering the microswitches, avoiding the problem of disorder of the trigger sequence. Therefore, an effective detection of the open state or the closed state of the microwave oven 1000 can be realized. In addition, the arm length of the rotation arm can be effectively reduced while ensuring the trigger sequence, in such a manner that a small space is occupied, which realizes a compact structure of the interlock device 100. Therefore, the interlock device 100 of the present disclosure can be applied to the microwave oven 1000 having a small volume and has strong versatility, which can effectively reduce manufacturing costs.

In addition, in some embodiments, the door body 200 of the microwave oven 1000 may further include the second door hook 12. For example, as illustrated in FIG. 19 to FIG. 34, the first door hook 11 is a lower door hook, and the second door hook 12 is an upper door hook. The lower door hook is disposed below the upper door hook. In other embodiments of the present disclosure, the door body 200 may further include a third door hook, or more door hooks, or the like. The door hooks are in a vertical direction arranged at intervals. In an embodiment where door hooks are provided, the first door hook 11 is configured to cooperate with the second lever 40 to indirectly trigger the two switches, ensuring that the two switches are switched on or off orderly.

The first door hook 11 may be a fixed door hook, i.e., fixed with respect to the door body 200, to allow the first door hook 11 to be stable in position and structure in a process of driving the second lever 40 to rotate. In this way, the orderly triggering for the microswitches can be prevented from being affected by a change in the position of the first door hook 11. Other door hooks such as the second door hook 12 and the third door hook may be fixed door hooks or movable door hooks. For example, the other door hooks may be rotatably or movably mounted at the door body 200.

The interlock device 100 of the microwave oven 1000 according to the embodiments of the present disclosure provides the above advantageous effects. Therefore, for the microwave oven 1000 according to the embodiment of the present disclosure, the first cooperation portion 45, the second cooperation portion 44, and the third cooperation portion 46 are sequentially arranged about the rotational axis of the second lever 40 in the first direction. The second cooperation portion 44 and the third cooperation portion 46 are capable of sequentially triggering corresponding microswitches after the first cooperation portion 45 is driven by the first door hook 11, which ensures orderliness of triggering the microswitches, avoiding the problem of disorder of the trigger sequence. Therefore, an effective detection of the open state or the closed state of the microwave oven 1000 can be realized. In addition, the arm length of the rotation arm can be effectively reduced while ensuring the trigger sequence, in such a manner that a small space is occupied, which realizes a compact structure of the interlock device 100. Therefore, the interlock device 100 of the present disclosure can be applied to the microwave oven 1000 having a small volume and has strong versatility, which can effectively reduce the manufacturing costs.

According to some embodiments of the present disclosure, as illustrated in FIG. 54 and FIG. 55, an angle formed between the first cooperation portion 45 and the second cooperation portion 44 with respect to an axis of the second lever 40 may be denoted by a, while an angle formed between the second cooperation portion 44 and the third cooperation portion 46 with respect to the axis of the second lever 40 may be denoted by β, where α<β. On the one hand, the orderly triggering for the microswitches can be more satisfactory. On the other hand, a space of the interlock device 100 occupied by the second lever 40 can be reduced through decreasing the angle formed between the first cooperation portion 45 and the second cooperation portion 44.

In an exemplary embodiment of the present disclosure, with the angle α formed between the first cooperation portion 45 and the second cooperation portion 44 about the rotational axis and the angle β formed between the second cooperation portion 44 and the third cooperation portion 46 about the rotational axis, an effect of orderly triggering can be realized in cooperation with the microswitches at the interlock support 20, which avoids the potential safety hazard of the microwave oven 1000 due to the disorder of the trigger sequence. After the first microswitch 202 is triggered by the second cooperation portion 44, the second lever 40 needs to continue rotating by the second predetermined angle to allow the third cooperation portion 46 to trigger the second microswitch 203. By allowing the angle β to be greater than the angle α, a distance between the second cooperation portion 44 and the third cooperation portion 46 at a plane perpendicular to the rotational axis can be increased. Therefore, satisfaction with the effect of the orderly triggering for the microswitches grows as the second predetermined angle increases.

With α<β, the angle between the first cooperation portion 45 and the second cooperation portion 44 with respect to the axis of the second lever 40 can be reasonably reduced when the angle between the second cooperation portion 44 and the third cooperation portion 46 with respect to the axis of the second lever 40 is constant. In this way, space resources of the interlock device 100 occupied by the second lever 40 can be reduced while ensuring the orderly triggering for the microswitches. Therefore, the position interference with other members in the interlock device 100 can be avoided, which is beneficial to realizing the compact structure of the interlock device 100.

As illustrated in FIG. 54 and FIG. 55, according to some embodiments of the present disclosure, a spacing between the first cooperation portion 45 and the axis of the second lever 40 may be greater than or equal to a spacing between the second cooperation portion 44 and the axis of the second lever 40, and is greater than or equal to a spacing between the third cooperation portion 46 and the axis of the second lever 40. On the one hand, the second lever 40 can occupy a small space, which is beneficial to realizing the compact structure of the interlock device 100. On the other hand, quick triggering for the interlock device 100 can be facilitated to allow the microwave oven 1000 to quickly enter an operation state.

In an exemplary embodiment of the present disclosure, when the spacing between the first cooperation portion 45 and the axis of the second lever 40 is constant, a distance between the second cooperation portion 44 and the rotational axis and a distance between the third cooperation portion 46 and the rotational axis can be reasonably reduced. In this way, the second lever 40 occupies less space resources. Further, the second lever 40 has a more compact structure, which in turn enables the interlock device 100 to have a more compact structure.

In addition, when the distance between the second cooperation portion 44 and the rotational axis and the distance between the third cooperation portion 46 and the rotational axis are constant, the spacing between the first cooperation portion 45 and the axis of the second lever 40 can be reasonably increased. During the door closing of the microwave oven 1000, the first door hook 11 may be in contact with the first cooperation portion 45 faster when moving in the door closing direction to drive the second lever 40 to rotate. Further, the second cooperation portion 44 and the third cooperation portion 46 can sequentially trigger the first microswitch 202 and the second microswitch 203 more quickly, and thus the microwave oven 1000 can quickly enter the operation state.

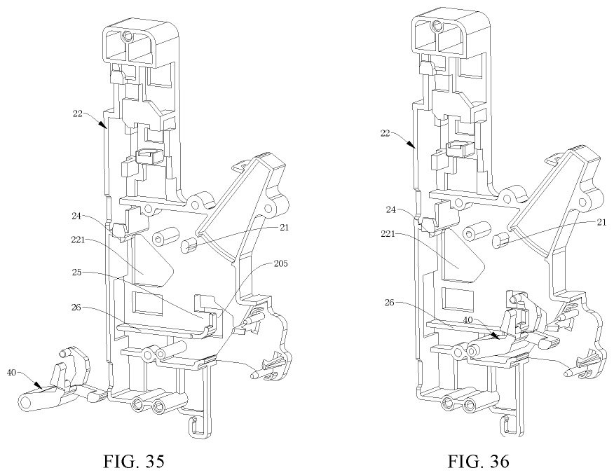

According to some embodiments of the present disclosure, as illustrated in FIG. 35 to FIG. 40 and FIG. 45 to FIG. 48, the interlock support 20 may have a mounting space 204. A side wall of the mounting space 204 has an avoidance recess 205. The first rotation arm 41 may be located at the avoidance recess 205. Therefore, the second lever 40 can be effectively prevented from being rotated by an elongated object, fingers, or the like brought into contact with the first rotation arm 41 after being inserted into the mounting space 204 in the door closing direction, which prevents the first microswitch 202 and the second microswitch 203 from being triggered by mistake.

In addition, the first cooperation portion 45 may extend into the mounting space 204, and the first door hook 11 is configured to extend into the mounting space 204. The first door hook 11 may be moved in the door closing direction within the mounting space 204 to close the microwave oven 1000. During the movement of the first door hook 11, the first door hook 11 may be in contact with the first cooperation portion 45 extending into the mounting space 204 to drive the second lever 40 to rotate.

It should be noted that, since the first cooperation portion 45 can be flexibly arranged at the first rotation arm 41 as desired, a position of the first cooperation portion 45 at the first rotation arm 41 can be changed to ensure that the first door hook 11 can be in contact with the first cooperation portion 45 to drive the second lever 40 to rotate. In one embodiment, other thin elongated objects like fingers are less likely to be in contact with the first cooperation portion 45 in the mounting space 204. In this way, objects other than the first door hook 11 can be effectively prevented from being brought into contact with the first cooperation portion 45 and then triggering the microswitch by mistake, ensuring use safety of the microwave oven 1000.

In some embodiments, the first cooperation portion 45 is located at a side surface of a top end of the first rotation arm 41, which can effectively avoid position interference between the first cooperation portion 45 and other members in the mounting space 204 on the one hand, and prevent other elongated objects from being brought into contact with the first cooperation portion 45 to avoid a rotation of the second lever 40 on the other hand. Therefore, the microwave oven 1000 has satisfactory safety performance.

In an embodiment where the interlock support 20 includes the support body 22 and the cover body 23, the cover body 23 covers the support body 22 to allow the cover body 23 to cooperate with the support body 22 to define the mounting space 204. As illustrated in FIG. 19, FIG. 21, FIG. 24, FIG. 28, and FIG. 30, the first microswitch 202 is disposed at the side of the cover body 23 facing away from the support body 22, and the second microswitch 203 is arranged in the mounting space 204. The cover body 23 may further have the second through hole 232 for passage of the second cooperation portion 44 of the second lever 40, in such a manner that the second cooperation portion 44 extends to the side of the cover body 23 facing away from the support body 22. During the rotation of the second lever 40, the second cooperation portion 44 rotates in the second through hole 232 with the second lever 40 to facilitate triggering for the first microswitch 202 located outside the mounting space 204. The third cooperation portion 46 is located in the mounting space 204 and is capable of triggering the second microswitch 203 located in the mounting space 204. The first microswitch 202 and the second microswitch 203 are located at different sides of the cover body 23, which prevents the first microswitch 202 and the second microswitch 203 from interfering with each other. For example, in the axial direction of the second lever 40, the projection of the first microswitch 202 may at least partially coincide with the projection of the second microswitch 203. In this way, the arrangement of the two microswitches can be more compact, and thus the first microswitch 202 and the second microswitch 203 can be sequentially triggered by the second lever 40 faster.

According to some embodiments of the present disclosure, as illustrated in FIG. 35 to FIG. 40 and FIG. 45 to FIG. 48, the interlock support 20 may include a first shield plate 25 capable of partially shielding a communication opening where the avoidance recess 205 is in communication with the mounting space 204, which can prevent fingers or other objects from being brought into contact with the first rotation arm 41 to avoid the rotation of the second lever 40. In addition, the first shield plate 25 can further be configured to limit a position of the first rotation arm 41.

In an exemplary embodiment of the present disclosure, the first rotation arm 41 may undergo a movement in a direction of the rotational axis in the avoidance recess 205. On the one hand, a stable state of the rotation lever fails to be satisfied. On the other hand, if a part or all of the first rotation arm 41 is moved out of the avoidance recess 205, fingers or other elongated objects can still drive the second lever 40 through the first rotation arm 41 when there is no obstruction. Therefore, there is still a risk of rotating the second lever 40 when the first rotation arm 41 is touched by mistake. With the first shield plate 25, the communication opening where the avoidance recess 205 is in communication with the mounting space 204 is partially shielded by the first shield plate 25. In this way, the first rotation arm 41 may be stably positioned in the avoidance recess 205 and is kept from moving to the mounting space 204, preventing the fingers or the like from being brought into contact with the first rotation arm 41. In addition, the first shield plate 25 can be further configured to limit and guide the first rotation arm 41. When the first door hook 11 abuts with the first cooperation portion 45 to drive the second lever 40 to rotate, the first shield plate 25 can form a cooperation groove with a side surface of the interlock support 20 facing towards the first rotation arm 41. The first rotation arm 41 can be configured to rotate smoothly in the cooperation groove to prevent the second cooperation portion 44 and the third cooperation portion 46 from being misaligned with the microswitches arranged corresponding to the second cooperation portion 44 and the third cooperation portion 46, avoiding inaccurate triggering for the microswitches. Therefore, the operation state of the microwave oven 1000 can be prevented from being affected due to the inaccurate triggering for the microswitches.

It should be noted that the first shield plate 25 is configured to partially shield, rather than completely shield, the communication opening where the avoidance recess 205 is in communication with the mounting space 204. If the first shield plate 25 is configured to completely shield the communication opening, the first rotation arm 41 is unable to enter the avoidance space through the communication opening. With the partial shielding, the first rotation arm 41 can be conveniently mounted while avoiding mistaken contact and providing a position limit, effectively saving operation hours and improving an assembly efficiency.

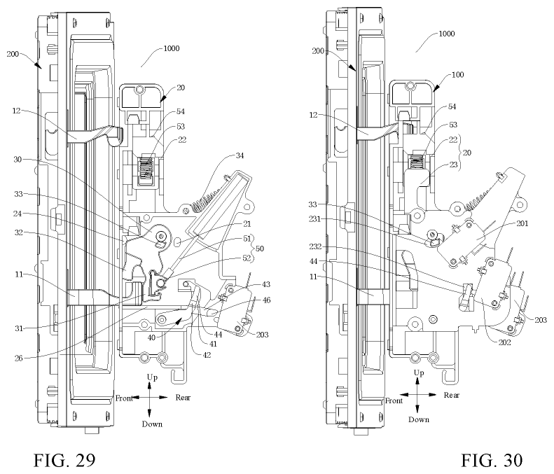

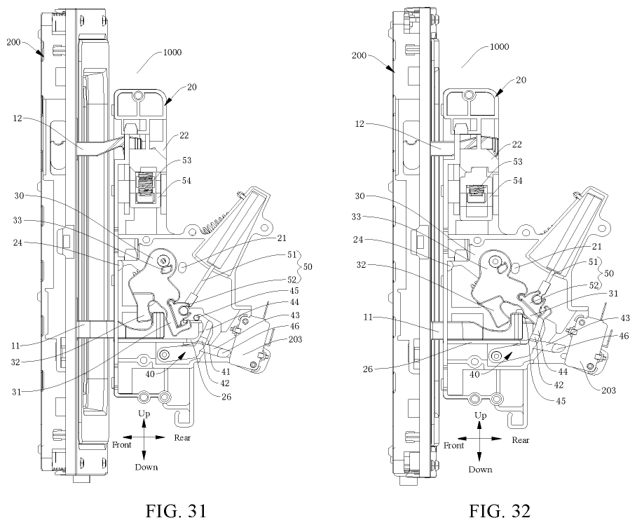

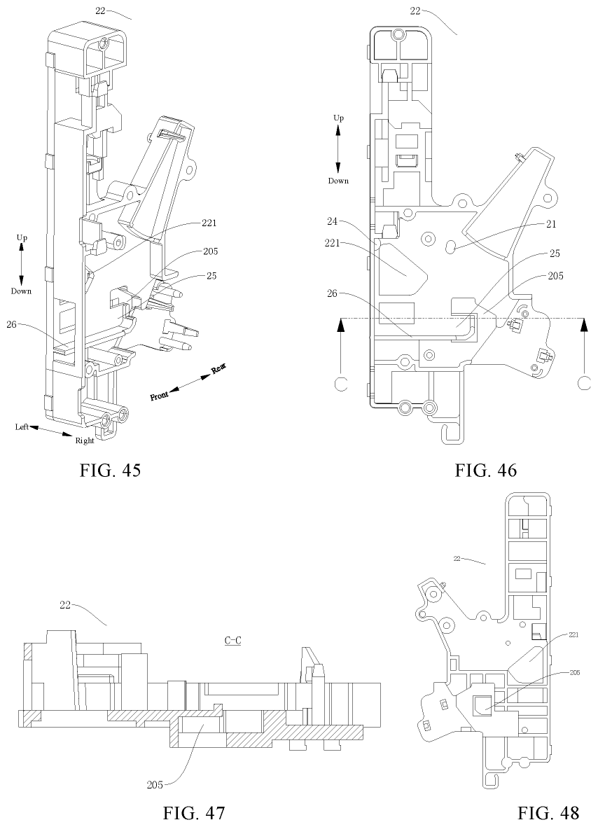

According to some embodiments of the present disclosure, as illustrated in FIG. 21, FIG. 26, FIG. 29, FIG. 31, and FIG. 45 to FIG. 48, the interlock support 20 may have a mounting space 204. The second rotation arm 42 is located in the mounting space 204. A second shield plate 26 is provided in the mounting space 204. A part of the second shield plate 26 is at least located at a side of the second rotation arm 42 close to the first door hook 11. With the second shield plate 26, the second rotation arm 42 can be prevented from being brought into contact with the fingers and the like, which avoids driving the second lever 40 to rotate due to mistaken contact with the second rotation arm 42. Therefore, mistaken contact with the microswitch occurred when the second lever 40 is driven to rotate can be avoided, which prevents the use safety of the microwave oven 1000 from being affected.

In an exemplary embodiment of the present disclosure, as illustrated in FIG. 45 to FIG. 48, since the part of the second shield plate 26 is at least located at the side of the second rotation arm 42 close to the first door hook 11, the second shield plate 26 is at least partially offset from the second rotation arm 42 in the door closing direction and is located at a side away from the first door hook 11. When the fingers or the elongated object is inserted into the mounting space 204 in the door closing direction, the fingers or the elongated object can be in contact with the second shield plate 26 but is less likely to be in contact with the second rotation arm 42. Therefore, the second lever 40 can be prevented from rotating due to mistaken contact with the second rotation arm 42.

In an embodiment where the mounting space 204 is defined by the support body 22 and the cover body 23, at least one of the support body 22 and the cover body 23 is provided with the second shield plate 26. That is, the second shield plate 26 may be disposed at the support body 22 or the cover body 23. Or each of the support body 22 and the cover body 23 is provided with the second shield plate 26 to prevent fingers or other objects from being brought into contact with the second rotation arm 42 by mistake. In some specific embodiments, as illustrated in FIG. 43 to FIG. 48, each of the support body 22 and the cover body 23 is provided with the second shield plate 26. The two second shield plates 26 can be spliced together. Therefore, in a direction parallel to the rotational axis, a distance over which the spliced second shield plate 26 extends is longer, achieving a better effect of preventing fingers or other objects from being brought into contact with the second rotation arm 42 by mistake.

It should be noted that a projection of the at least part of the second shield plate 26 in the direction of the rotational axis may be an arc segment illustrated in FIG. 46. One end of the arc segment extends towards the first door hook 11 in the door closing direction. Another end of the arc segment extends upwards in a direction perpendicular to the door closing direction illustrated in FIG. 28. The projection may also be of other shapes, which are not specifically limited by the embodiments of the present disclosure.

In an embodiment where the interlock device 100 includes the second shield plate 26, as illustrated in FIG. 35 to FIG. 40, FIG. 45, and FIG. 46, the part of the second shield plate 26 may extend in the door closing direction and is located between the rotational axis of the second lever 40 and the first door hook 11. On the one hand, the part of the second shield plate 26 can function as a limit and guide for the first door hook 11 and serve as a track for the movement of the first door hook 11. The first door hook 11 is configured to move in the door closing direction along the part of the second shield plate 26, and thus precisely abuts with the first cooperation portion 45 to drive the second lever 40 to rotate. On the other hand, this part is located between the rotational axis and the first door hook 11, which is beneficial to preventing objects like fingers from being brought into contact with the rotational axis of the second lever 40 to avoid mistaken triggering for the microswitch.

According to some embodiments of the present disclosure, as illustrated in FIG. 44, the interlock support 20 may have a mounting space 204. The third rotation arm 43 is located in the mounting space 204. A third shield plate 27 is provided in the mounting space 204 and is located at a side of the third rotation arm 43 close to the first door hook 11. In this way, fingers or other objects can be prevented from being brought into contact with the third rotation arm 43, which prevents the second lever 40 from being driven to rotate due to mistaken contact with the third rotation arm 43. Therefore, an influence on the use safety of the microwave oven 1000 can be avoided.

In an exemplary embodiment of the present disclosure, a projection of the third shield plate 27 at least partially coincides with a projection of the door hook in the door closing direction. In addition, the third shield plate is closer to the first door hook 11 than the third rotation arm 43 in the door closing direction. Therefore, the third shield plate 27 can block objects such as fingers.

In an embodiment where the interlock support 20 includes the support body 22 and the cover body 23, as illustrated in FIG. 44, at least one of the support body 22 and the cover body 23 is provided with the third shield plate. That is, the third shield plate may be disposed at the support body 22 or the cover body 23. Or each of the support body 22 and the cover body 23 may be provided with the third shield plate to prevent fingers or other objects from being brought into contact with the third rotation arm 43 by mistake.

According to some embodiments of the present disclosure, as illustrated in FIG. 19 to FIG. 43, the interlock device 100 further includes a monitoring switch 201 and a first lever 30. The monitoring switch 201 is provided at the interlock support 20. The first lever 30 is rotatably provided at the interlock support 20. The first door hook 11 is further configured to drive, before driving the second lever 40 to rotate, the first lever 30 to rotate in a second direction to trigger the monitoring switch 201. Therefore, the monitoring switch 201, the first microswitch 202, and the second microswitch 203 can be triggered orderly.

During the door closing of the microwave oven 1000, the first door hook 11 is first brought into contact with the first lever 30 at the interlock support 20 and drives the first lever 30 to rotate in the second direction (a counterclockwise direction illustrated in FIG. 29). When the first lever 30 rotates by the predetermined angle, the first lever 30 triggers the monitoring switch 201. Then, the first door hook 11 is in contact with the second lever 40 and drives the second lever 40 to rotate in the second direction (a clockwise direction illustrated in FIG. 29). When the second lever 40 rotates by the first predetermined angle, the first microswitch 202 is triggered. When the second lever 40 continues to rotate until the second predetermined angle is reached, the second microswitch 203 is triggered. Thus, the monitoring switch 201, the first microswitch 202, and the second microswitch 203 are sequentially and orderly triggered.

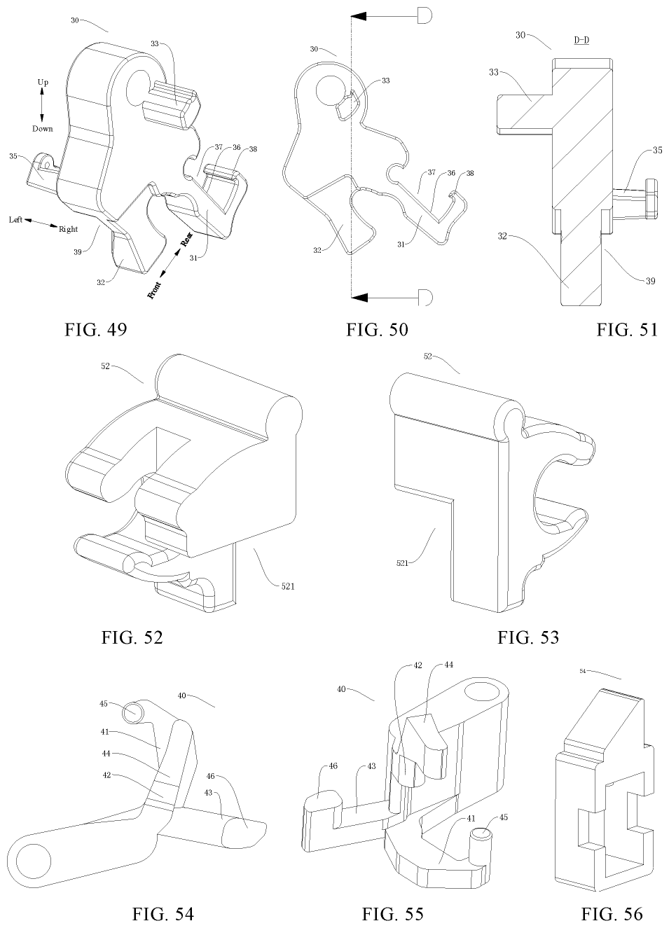

According to some embodiments of the present disclosure, as illustrated in FIG. 49 and FIG. 50, the first lever 30 may include a first drive arm 31. The first drive arm 31 may be provided with a first drive portion 33 configured to drive the monitoring switch 201.

It should be noted that the position of the first drive portion 33 at the first drive arm 31 can be flexibly arranged based on actual conditions such as a spatial arrangement. For example, the first drive portion 33 may be provided at any position such as the middle or the end of the first drive arm 31 in a length direction of the first drive arm 31.

In some embodiments, the first drive portion 33 may be the protrusion disposed at the side of the first drive arm 31 in the axial direction. In this way, the first drive portion 33 is free from interference of the first drive arm 31 during cooperation with the monitoring switch 201, which avoids the risk of bringing the first drive arm 31 into contact with the monitoring switch 201 by mistake.

In the embodiment where the mounting space 204 is defined by the support body 22 and the cover body 23, as illustrated in FIG. 19, FIG. 24, FIG. 28, FIG. 30, FIG. 43, and FIG. 44, the monitoring switch 201 is arranged at the side of the cover body 23 facing away from the support body 22. The cover body 23 has the first through hole 231. The first lever 30 is provided with the first drive portion 33. The first drive portion 33 is capable of passing through the first through hole 231 to extend to the side of the cover body 23 facing away from the support body 22. During the rotation of the first lever 30, the first drive portion 33 rotates in the first through hole 231 with the first lever 30 to facilitate the triggering for the monitoring switch 201. The monitoring switch 201 may be disposed outside the mounting space 204 to avoid the position interference with the members in the mounting space 204, such as avoiding the interference with the door closing buffer assembly 50, which enables the position arrangement to be reasonable.

In addition, as illustrated in FIG. 21, FIG. 26, FIG. 29, FIG. 31, and FIG. 49 to FIG. 51, the first lever 30 may further include the second drive arm 32 located at the side of the first drive arm 31 close to the first door hook 11. That is, the first drive arm 31 is located at a leading side of the second drive arm 32 in the second direction.

The first door hook 11 is configured to abut with the first drive arm 31 to drive the first lever 30 to rotate. As illustrated in FIG. 28 to FIG. 32, the first door hook 11 may abut with the first drive arm 31 during the door closing of the microwave oven 1000, to drive the first drive arm 31 to rotate about the rotational axis of the first lever 30 in the second direction. Therefore, the first drive portion 33 can be driven to rotate. In this way, the first drive portion 33 can rotate to the position triggering the monitoring switch 201 to switch on the monitoring switch 201.

As illustrated in FIG. 19 to FIG. 21, the first cooperation portion 45 is located between the first drive arm 31 and the second drive arm 32 in the door closed state, which can ensure that the first cooperation portion 45 is in no contact with fingers or other objects. In an exemplary embodiment of the present disclosure, when inserted into the mounting space 204, fingers or other objects come into contact with the first drive arm 31 initially to allow the first lever 30 to rotate in the second direction. However, as the first lever 30 rotates, the second drive arm 32 has position interference with fingers to block further insertion of the fingers. In this way, the fingers come into no contact with the first cooperation portion 45 of the second lever 40, and thus no contact is made to the second lever 40 to prevent the second lever 40 from being rotated. The first microswitch 202 and the second microswitch 203 will not be triggered. After the first door hook 11 is inserted into the mounting space 204, since the first door hook 11 has a recessed portion configured to avoid the second drive arm 32, the second drive arm 32 is kept from hindering further insertion of the first door hook 11. Therefore, the first door hook 11 can be in contact with the first cooperation portion 45 to drive the second lever 40 to rotate.

In some embodiments of the present disclosure, as illustrated in FIG. 34, FIG. 49, and FIG. 51, in the axial direction of the first lever 30, the second drive arm 32 has the thinned region 39 located at at least one surface of the second drive arm 32. Therefore, when the first lever 30 is mounted at the interlock support 20, the predetermined gap can be formed between the thinned region 39 of the second drive arm 32 and the interlock support 20. When the first lever 30 is rotated in the second direction to the position triggering the monitoring switch 201 due to being triggered by mistake, the first door hook 11 may forcibly pass through the gap and move to the position between the first drive arm 31 and the second drive arm 32 through closing the door. Then through opening the door, the first door hook 11 may drive the first lever 30 to rotate in the first direction for restoring the position of the first lever 30.

As illustrated in FIG. 19, the interlock support 20 includes the support body 22 and the cover body 23. The first lever 30 is mounted between the support body 22 and the cover body 23. The thinned region 39 may be a notch groove formed at the side of the second drive arm 32 facing towards the support body 22, which enables the gap to be formed between the second drive arm 32 and the support body 22.

In addition, in some embodiments of the present disclosure, as illustrated in FIG. 57 and FIG. 58, the first door hook 11 may have the thickness gradually decreasing in the door closing direction. Thus, the rear end of the first door hook 11 has a smaller thickness, while the front end of the first door hook 11 has a greater thickness, as illustrated in FIG. 57. When the first lever 30 triggers the monitoring switch 201 by mistake, the structure of thick front end and thin rear end of the first door hook 11 enables the first door hook 11 to be moved from the thinned region 39 to the position between the first drive arm 31 and the second drive arm 32 easily. Therefore, the abnormal triggering problem can be solved easily.

In some embodiments of the present disclosure, as illustrated in FIG. 48 and FIG. 51, in the axial direction of the first lever 30, the first drive arm 31 may be spaced apart from the first cooperation portion 45 by a predetermined gap to ensure that when the first drive arm 31 rotates to the position of the first cooperation portion 45 in the second direction, the first drive arm 31 is in no contact with the first cooperation portion 45, and thus the second lever 40 is kept from being driven to rotate. Therefore, an abnormal situation where the door body 200 is not fully closed but the monitoring switch 201 and the microswitches are triggered is avoided.

According to some embodiments of the present disclosure, as illustrated in FIG. 39 and FIG. 40, the interlock device 100 may further include the elastic member 34 connected to the interlock support 20 and the first lever 30. For example, the elastic member 34 may be a coil spring. One or a plurality of coil springs may be provided. In examples illustrated in FIG. 19 to FIG. 34, two elastic members 34 are provided and each are a tension spring. As illustrated in FIG. 49 to FIG. 51, the first lever 30 is provided with the connection portion 35. The connection portion 35 is the protrusion provided at the side surface of the first lever 30 facing away from the first drive portion 33. Each tension spring has the end connected to the interlock support 20 and the other end connected to the connection portion 35. The two tension springs are spaced apart from each other at one end by the predetermined distance.

Further, the elastic member 34 has the first drive state. The elastic member 34 is configured to apply a drive force for rotating the first lever 30 in the second direction to the first lever 30 in the first drive state to allow the second drive arm 32 to drive the first door hook 11 to move in the door closing direction.

In an exemplary embodiment of the present disclosure, as illustrated in FIG. 28 to FIG. 32, the first door hook 11 is configured to move in the door closing direction to the position between the first drive arm 31 and the second drive arm 32 and abut with the first drive arm 31 during the door closing of the microwave oven 1000, to drive the first lever 30 to start rotating in the second direction. When the first lever 30 starts to rotate in the second direction or rotates by a small angle, the elastic member 34 is in the first drive state to automatically drive the first lever 30 to rotate in the second direction. In this way, the first door hook 11 is driven by the second drive arm 32 to continue to move in the door closing direction, in such a manner that the automatic door closing function is realized. In this case, even if the user cancels the force exerted on the door body 200 for closing the door body 200, the door body 200 can still be ensured to be closed properly, and thus the first door hook 11 can be ensured to move in the door closing direction until all three switches are triggered. On the one hand, the user can operate the door body 200 with less effort and more convenience. On the other hand, the problem of failing to close the door properly can be avoided.

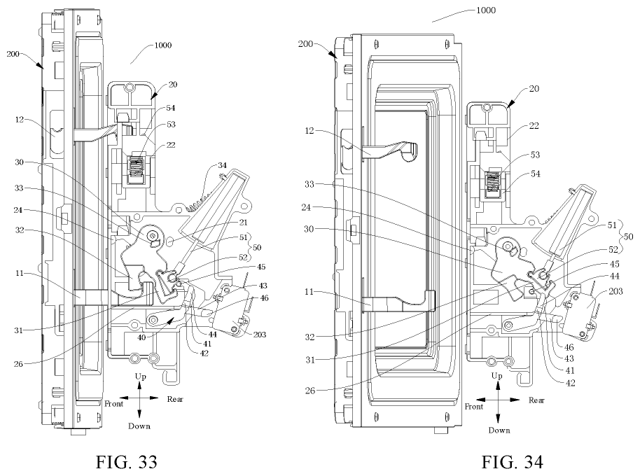

In some embodiments, as illustrated in FIG. 33, the elastic member 34 has the second drive state. The elastic member 34 is further configured to apply a drive force for rotating the first lever 30 in the first direction to the first lever 30 in the second drive state. The first door hook 11 is further configured to abut with the first drive arm 31 during the door closing of the microwave oven 1000 to switch the elastic member 34 from the second drive state into the first drive state.

In an exemplary embodiment of the present disclosure, in the door opened state, the first lever 30 may be maintained at the desired position by the elastic member 34. On the one hand, the first lever 30 can be prevented from rotating in the first direction without being acted upon by the first door hook 11, avoiding mistakenly triggering the monitoring switch 201. On the other hand, the first door hook 11 can be ensured to move smoothly to the position between the first drive arm 31 and the second drive arm 32 during the door closing of the microwave oven 1000 to prevent the first lever 30 from rotating and affecting the cooperation between the first door hook 11 and the first lever 30. In addition, the first door hook 11 and the first drive arm 31 abut with each other to drive the first lever 30 to rotate in the second direction, which enables the elastic member 34 to switch the drive state in time along with the rotation of the first lever 30, and ensures that the elastic member 34 can drive the door to close in time.

In the door closed state, the elastic member 34 is in the first drive state to allow the first lever 30 to abut with the first door hook 11 through the second drive arm 32, ensuring that the door body 200 remains in the closed state. When the door needs to be opened, the first door hook 11 is controlled by the user to move in the door opening direction and to abut with the second drive arm 32, enabling the first lever 30 to rotate in the first direction. When the first lever 30 rotates by the predetermined angle, the elastic member 34 is switched from the first drive state into the second drive state, which allows the elastic member 34 to drive the first lever 30 to rotate in the first direction to release the resistance on the first door hook 11 in time. Thus, the door body 200 can be opened easily.

In an embodiment where the elastic member 34 is a spring, the spring remains in a stretched state in both the first drive state and the second drive state.

According to some embodiments of the present disclosure, as illustrated in FIG. 35 to FIG. 39 and FIG. 46, the interlock support 20 may be provided with the first limit portion 21. The first limit portion 21 is configured to abut with the first lever 30 in the door closed state to block the first lever 30 from rotating in the second direction. In other words, the first limit portion 21 can limit a limit position the first lever 30 is rotated to in the second direction, to avoid damages to the monitoring switch 201 or the first door hook 11 caused by an excessive rotation angle of the first lever 30.

For example, in an embodiment where the elastic member 34 is provided, the elastic member 34 drives the first lever 30 to rotate in the second direction to drive the first door hook 11 to move in the door closing direction, realizing automatic door closing. When the first lever 30 is rotated until the first lever 30 abuts with the first limit portion 21, the limitation of the first limit portion 21 realizes the force balance of the first lever 30, and thus the first lever 30 is kept from rotating under the driving of the elastic member 34. The first lever 30 can be maintained at the position that provides the stable engagement with the first door hook 11 and keeps the door body 200 closed.

According to some embodiments of the present disclosure, as illustrated in FIG. 35 to FIG. 40, the interlock support 20 may be provided with a second limit portion 24. In the door opened state, the second limit portion 24 is configured to abut with the first lever 30 to prevent the first lever 30 from rotating in the first direction. In other words, the second limit portion 24 can limit a limit position the first lever 30 is rotated to in the first direction, which avoids position interference caused by an excessive rotation angle of the first lever 30 in the first direction. Therefore, the first door hook 11 can be in normal contact with and cooperate with the first lever 30 during the door closing of the microwave oven 1000 to avoid affecting user experience.

According to some embodiments of the present disclosure, as illustrated in FIG. 19 to FIG. 34, FIG. 39, and FIG. 40, the interlock device 100 may further include the door closing buffer assembly 50 connected to the interlock support 20 and the first lever 30. For example, the door closing buffer assembly 50 is connected to the first drive arm 31 of the first lever 30.

The door closing buffer assembly 50 is configured to apply a buffer force to the first lever 30 in a direction opposite to the second direction during the door closing of the microwave oven 1000. Therefore, the buffer action for the door closing of the microwave oven 1000 can be realized, which avoids the violent collision between the door body 200 and the machine body during the door closing of the microwave oven 1000, and also facilitates the noise reduction during the door closing of the microwave oven 1000.

The specific structure of the door closing buffer assembly 50 is not specifically limited in the present disclosure, as long as the structure can provide the buffer action for the door closing of the microwave oven 1000. For example, the door closing buffer assembly 50 may include a damper, a spring, a compression spring, or the like.

For example, in some embodiments, as illustrated in FIG. 39 and FIG. 40, the door closing buffer assembly 50 includes the buffer member 51 and the connector 52. The buffer member 51 has the end rotatably connected to the interlock support 20. The connector 52 is rotatably connected to the other end of the buffer member 51 and the first drive arm 31, respectively. In this way, during the rotation of the first lever 30, the buffer member 51 serves as a buffer, while such a rotatable connection structure is adapted to the rotation of the first lever 30 to avoid jamming.

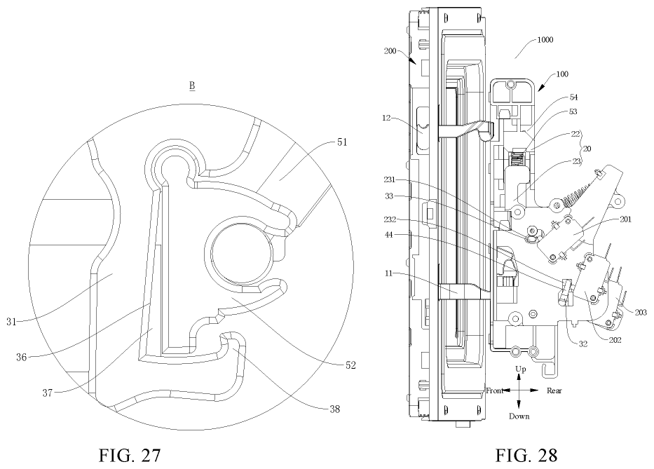

In addition, as illustrated in FIG. 39, FIG. 40, FIG. 49, and FIG. 50, the first drive arm 31 has the drive surface 36. The connector 52 is rotatably mounted at the first drive arm 31. Further, as illustrated in FIG. 26 and FIG. 27, the connector 52 forms the predetermined angle with the drive surface 36 in the door opened state. The other end of the buffer member 51 is rotatably connected to the connector 52. The drive surface 36 is capable of abutting with the connector 52 after the first lever rotates by the predetermined angle in the first direction during the door closing of the microwave oven 1000, to drive the connector 52 to rotate.

Since the connector 52 is arranged at the predetermined angle to the drive surface 36 in the door opened state, when the first door hook 11 is just in contact with the first lever 30 and drives the first lever 30 to rotate in the second direction, the buffer member 51 is kept from applying the buffer force to the first lever 30, which enables the first door hook 11 to easily drive the first lever 30 to rotate.

In some specific embodiments, as illustrated in FIG. 22, FIG. 27, FIG. 49, and FIG. 50, the side of the first drive arm 31 facing towards the door closing buffer assembly 50 has the groove 37. The bottom wall surface of the groove 37 is formed as the drive surface 36. One side surface of the groove 37 is connected to the hole shaft of the connector 52, while the other side surface of the groove 37 is provided with the curved hook 38 spaced apart from the drive surface 36 by the predetermined distance. The buffer member 51 is a damper. The damper is connected to the hole shaft of the connector 52 through the opening of the groove 37. The interlock device 100 further includes the elastic member 34 connected to the first lever 30.

The elastic member 34 is configured to apply a drive force for rotating the first lever 30 in the first direction in the door opened state, which enables the first door hook 11 to be smoothly moved until abutting with the first drive arm 31. In this case, the connector 52 and the drive surface 36 form the predetermined angle to keep the damper from generating the buffer force. The first door hook 11 is in contact with the first drive arm 31 and is configured to drive the first lever 30 to rotate in the second direction during the door closing of the microwave oven 1000. Since the damper provides no buffer force, the first door hook 11 only needs to drive the first lever 30 against the drive force of the elastic member 34, and thus a small resistance is generated. When the first lever 30 rotates until the connector 52 abuts with the drive surface 36, a state of the elastic member 34 is switched into applying the drive force for rotating the first lever 30 in the second direction to actively drive the first lever 30 to rotate, the first door hook 11 to move, and the door body 200 to close. In this case, the damper generates the buffer force to reduce noises generated during the door closing of the microwave oven 1000. The first door hook 11 is configured to pull the first lever 30 to rotate in the first direction and the connector 52 is configured to rotate relative to the first drive arm 31 during the door opening of the microwave oven 1000. In this way, the predetermined angle is formed between the connector 52 and the drive surface 36, and the curved hook 38 abuts with the connector 52 to prevent the angle from being too large and prevent the connector 52 from falling out of the groove 37, which ensure the connector 52 to be stably connected to the first lever 30.

For example, in other embodiments, the door closing buffer assembly 50 may include the buffer member 51. The buffer member 51 is an elastic sheet or a compression spring. The door closing buffer assembly 50 is formed as the buffer energy accumulation assembly. In an exemplary embodiment of the present disclosure, the one end of the elastic sheet is connected to the interlock support 20, and the first lever 30 abuts with the other end of the elastic sheet. The elastic sheet can be elastically deformed to accumulate energy.

The first lever 30 is configured to rotate in the first direction and compress the other end of the elastic sheet during the door closing of the microwave oven 1000, to increase the bending degree of the elastic sheet and accumulate energy, which achieves the buffer action and energy accumulation. During the door opening of the microwave oven 1000, the elastic sheet can release the accumulated energy to apply the drive force for rotating the first lever 30 in the first direction. Therefore, the first lever 30 can push the first door hook 11 and the door body 200 to move towards the door opening direction, which is conducive to the door opening of the microwave oven 1000. In the door closed state, the direction of the drive force exerted by the elastic sheet on the first lever 30 is directed towards the rotation center of the first lever 30 or near the rotation center of the first lever 30. In this case, no component force or only a small component force is provided by the elastic sheet in the rotation direction of the first lever 30, which ensures the door body 200 to be tightly closed.

In some embodiments of the present disclosure, as illustrated in FIG. 52 and FIG. 53, in the axial direction of the first lever 30, the connector 52 may have an avoidance notch 521 formed at a side surface of the connector 52. The avoidance notch 521 is configured to avoid the first cooperation portion 45. With the avoidance notch 521, a gap is formed between the connector 52 and an end surface of the first cooperation portion 45 in the axial direction of the first lever 30, which can ensure that during the rotation of the first lever 30, the connector 52 is prevented from being in contact with the first cooperation portion 45 to trigger the second lever 40 to rotate. Therefore, the disorder of the trigger sequence of the monitoring switch 201 and the microswitches is avoided.

The interlock device 100 of the microwave oven 1000 according to a specific embodiment of the present disclosure is described in detail below with reference to the accompanying drawings. It should be understood that the following description is illustrative only and should not be construed as a limitation of the present disclosure.

As illustrated in FIG. 19 to FIG. 58, the microwave oven 1000 according to the embodiment of the present disclosure includes the door body 200, the machine body, and the interlock device 100. The interlock device 100 includes the first door hook 11, the second door hook 12, the interlock support 20, the first shield plate 25, the second shield plate 26, the third shield plate, the first lever 30, the second lever 40, the monitoring switch 201, the first microswitch 202, the second microswitch 203, the elastic member 34, the door closing buffer assembly 50, the driver 53, and the inclined block 54.

As illustrated in FIG. 21, FIG. 41, and FIG. 42, the door body 200 is rotatably mounted at the machine body around the vertical axis. The first door hook 11 and the second door hook 12 are fixedly mounted at the door body 200. Further, the second door hook 12 is located above the first door hook 11. The interlock support 20 is mounted at the machine body and includes the support body 22 and the cover body 23 to define the mounting space 204. The side wall of the mounting space 204 has the avoidance recess 205. The support body 22 includes the first shield plate 25 partially shielding the communication opening where the avoidance recess 205 is in communication with the mounting space 204. The second shield plate 26 and the third shield plate 27 are provided in the mounting space 204. The second shield plate 26 is in a slide shape. The third shield plate 27 is in a rectangular shape.

As illustrated in FIG. 35, FIG. 36, FIG. 39, and FIG. 40, each of the first lever 30 and the second lever 40 is rotatably mounted in the mounting space 204. The first lever 30 includes the first drive arm 31, the second drive arm 32, and the first drive portion 33 passing through the first through hole 231 of the cover body 23. The second lever 40 includes the first rotation arm 41 provided with the first cooperation portion 45, the second rotation arm 42 provided with the second cooperation portion 44, and the third rotation arm 43 provided with the third cooperation portion 46. The second cooperation portion 44 passes through the second through hole 232 of the cover body 23. In addition, the second shield plate 26 has a curved segment located at the side of the second rotation arm 42 close to the first door hook 11 and a flat segment located between the rotational axis of the second lever 40 and the first door hook 11. The third shield plate is located at the side of the third rotation arm 43 close to the first door hook 11. Further, the first rotation arm 41 is located in the avoidance recess 205. The first cooperation portion 45 extends into the mounting space 204.

As illustrated in FIG. 19, FIG. 21, FIG. 45, FIG. 46, and FIG. 48, the second microswitch 203 is arranged in the mounting space 204, and the monitoring switch 201 and the first microswitch 202 are disposed at the side of the cover body 23 facing away from the support body 22. The support body 22 has the third through hole 221. The elastic member 34 is arranged at the side of the support body 22 facing away from the cover body 23. The connection portion 35 of the first lever 30 passes through the third through hole 221 to be connected to the elastic member 34.

In addition, the inclined block 54 is movably mounted at the support body 22 in a vertical direction. The two ends of the driver 53 abut against the inclined block 54 and the support body 22, respectively, to apply the upward driving force to the inclined block 54.

As illustrated in FIG. 23 to FIG. 26, the first door hook 11 and the second door hook 12 are separated from the machine body in the door opened state. The driver 53 drives the inclined block 54 to a high position. The first lever 30 rotates in the clockwise direction to the limit position against the edge of the support body 22 under the pulling force of the elastic member 34 and is separated from the monitoring switch 20. The second lever 40 is at the position separated from the first microswitch 202 and the second microswitch 203.

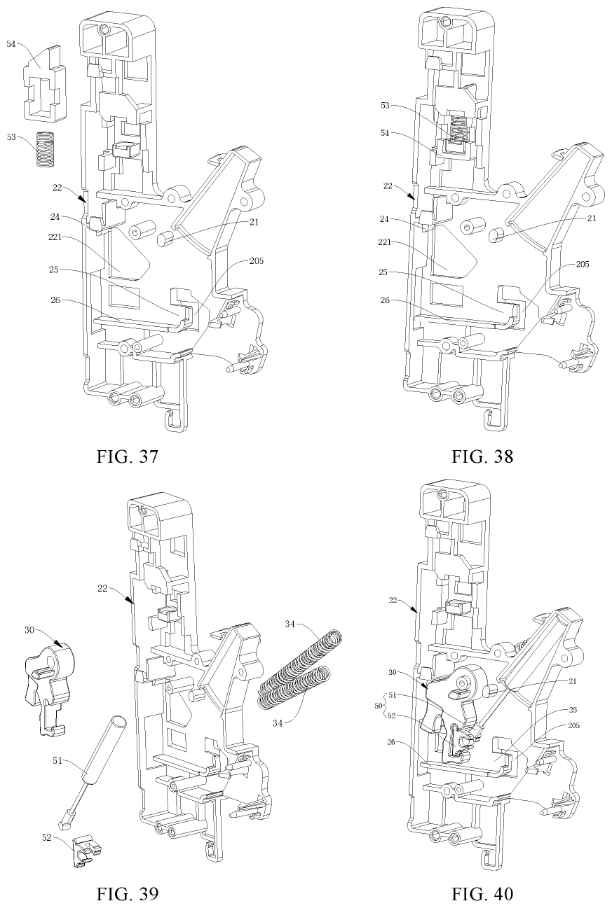

As illustrated in FIG. 28 to FIG. 32, during the door closing of the microwave oven 1000, the door body 200 is pushed to allow the first door hook 11 and the second door hook 12 to move in the door closing direction, i.e., to move backwards. The first door hook 11 moves in the door closing direction under a limit of the second shield plate 26. The rear end of the first door hook 11 extends to the position between the first drive arm 31 and the second drive arm 32 and is configured to abut with the first drive arm 31 to push the first lever 30 to rotate in the counterclockwise direction. When the first lever 30 rotates by the predetermined angle, the pulling force of the elastic member 34 is switched to drive the first lever 30 to rotate in the counterclockwise direction, which allows the second drive arm 32 of the first lever 30 to automatically pull the first door hook 11 to move backwards. Further, the connector 52 is in contact with the drive surface 36. The drive surface 36 is configured to drive the connector 52 to move. The buffer member 51 provides the buffer action. The first lever 30 rotates to enable the first drive portion 33 to trigger the monitoring switch 201. Then, when moved until being brought into contact with the first cooperation portion 45 of the second lever 40, the first door hook 11 may drive the second lever 40 to rotate in the clockwise direction. The first microswitch 202 and the second microswitch 203 are sequentially triggered by the second cooperation portion 44 and the third cooperation portion 45 of the second lever 40. The second door hook 12 is configured to abut with the inclined block 54 during the door closing of the microwave oven 1000, as illustrated in FIG. 37 and FIG. 38. The inclined block 54 is configured to compress the driver 53 to move the hook portion of the second door hook 12 to the rear side of the inclined block 54. In this way, the position of the second door hook 12 is limited by the inclined block 54 to keep the door body 200 closed.

As illustrated in FIG. 19 to FIG. 21, the first lever 30 is configured to stop rotating when rotated until abutting with the first limit portion 21, and the second lever 40 is configured to stop rotating after triggering the second microswitch 203. In this case, under the pulling force of the elastic member 34, the first door hook 11 is blocked by the second drive arm 32 of the first lever 30. Therefore, the door body 200 is kept in the door closed state, and the first lever 30 and the second lever 40 are kept in the positions where the monitoring switch 201, the first microswitch 202, and the second microswitch 203 are enabled to be switched on.

The door body 200 is configured to rotate in reverse to be opened during the door opening of the microwave oven 1000 to allow the first door hook 11 to move forwards, as illustrated in FIG. 33. In the movement process, the block force against the second lever 40 is first canceled. The second lever 40 is configured to rotate in the counterclockwise direction under the rebound force of the first microswitch 202 and the rebound force of the second microswitch 203 to cancel the triggering for the first microswitch 202 and the second microswitch 203. Further, the first door hook 11 is configured to abut with the second drive arm 32 during the movement of the first door hook 11 to drive the first lever 30 against the elastic force of the elastic member 34 and to rotate in the clockwise direction. In this way, triggering for the monitoring switch 201 is released by the first drive portion 33. When the first lever rotates until the pulling force of the elastic member 34 is switched to drive the first lever 30 to rotate in the clockwise direction, the first lever 30 is automatically restored to the position against the first limit portion 21 under the driving of the elastic member 34 and stays at the position. In addition, the first lever 30 is capable of driving the first door hook 11 to move forwards, which allows the door body 200 to be sprang open. The second door hook 12 is configured to abut with the inclined block 54 again during the door opening of the microwave oven 1000, as illustrated in FIG. 37 and FIG. 38. The inclined block 54 is configured to compress the driver 53 to move the hook portion of the second door hook 12 to the front side of the inclined block 54, in such a manner that the limit exerted by the inclined block 54 on the second door hook 12 can be released for opening the door body 200.

In summary, the first door hook 11 cooperates with the two levers to trigger the three switches, respectively. The switches are in indirect contact with the first door hook 11. Further, the monitoring switch 201, the first microswitch 202, and the second microswitch 203 can be triggered sequentially, which ensures the safety of the machine. In addition, the interlock device 100 has a compact structure and low manufacturing costs.

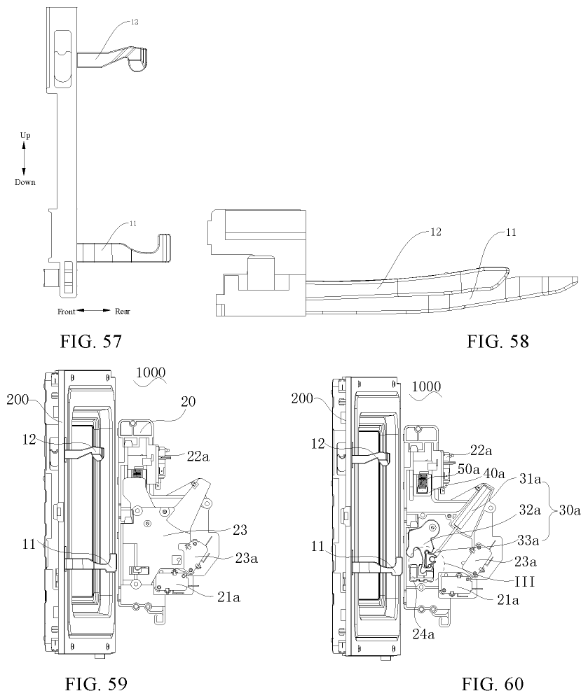

As illustrated in FIG. 59 and FIG. 60, a microwave oven 1000 according to one embodiment of the present disclosure includes a door body 200, an interlock support 20, and a damping assembly 30a. The door body 200 has a first door hook 11 and a second door hook 12. The door body 200 is movably connected to the interlock support 20 and is fixedly provided with a first switch 21a, a second switch 22a, and a third switch 23a. The damping assembly 30a is mounted at the interlock support 20 and includes a damper 31a and a drive lever 32a. The drive lever 32a is rotatably connected to the interlock support 20 and the damper 31a. The microwave oven 1000 is configured and during closing of the door body 200, the first door hook 11 directly abuts with the first switch 21a to trigger the first switch 21a, the second door hook 12 directly abuts with the second switch 22a to trigger the second switch 22a, and the first door hook 11 triggers the third switch 23a through the drive lever 32a.

With the microwave oven 1000 of the embodiment of the present disclosure, the first door hook 11 directly abuts with the first switch 21a to trigger the first switch 21a, and the second door hook 12 directly abuts with the second switch 22a to trigger the second switch 22a. In this way, the first switch 21a, the second switch 22a, and the third switch 23a can be ensured to be triggered sequentially, which avoids the problem of disorder of the trigger sequence of the switches.

In an exemplary embodiment of the present disclosure, the microwave oven 1000 includes the door body 200. The door body 200 may be a double-glazed glass door body or a wave-leak-proof glass door body. One of the advantages of using the glass door body is that it is convenient for the user to observe food inside the microwave oven 1000 from outside. In addition, an outer surface of the door body 200 may be provided with a handle, which is convenient for the user to open or close the door. Two door hooks are mounted at the door body 200, namely the second door hook 12 and the first door hook 11. The microwave oven 1000 includes the first switch 21a, the second switch 22a, and the third switch 23a. The first switch 21a may be a monitoring switch for monitoring an entire circuit of the microwave oven 1000. The second switch 22a may be a secondary switch for controlling a lamp and a cooling fan or other members to be switched on. The third switch 23a may be a primary switch for controlling a microwave function of the microwave oven 1000. The second door hook 12 is configured to trigger the second switch 22a. That is, the second door hook 12 is configured to trigger the secondary switch. The first door hook 11 is configured to directly trigger the first switch 21a. That is, the first door hook 11 is configured to directly trigger the monitoring switch. The first door hook 11 is configured to trigger the third switch 23a through the drive lever 32a. That is, the first door hook 11 is configured to indirectly trigger the primary switch.

The trigger sequence of the three switches is particularly important during the user's use of the microwave oven 1000. During the door closing of the microwave oven 1000, the trigger sequence should follow that the monitoring switch is triggered first, then the secondary switch, and finally the primary switch. In this way, use safety can be guaranteed for the user. During the door opening of the microwave oven 1000, the trigger sequence should follow that the primary switch is triggered first, then the secondary switch, and finally the monitoring switch. In this way, the use safety can be guaranteed for the user. However, in the related art, due to different layouts of the door hook, the movable door hook, or other situations, the problem of disorder of the trigger sequence of the three switches during the door opening of the microwave oven is likely to occur in the microwave oven. A specific reason for the problem is that when the user pushes the door manually to close the door body, the second door hook accelerates under force to trigger the secondary switch. Further, since the drive lever is connected to the damper, the drive lever decelerates during movement. When an acceleration of manually pushing the door exceeds a rotation speed of the drive lever, the primary switch is triggered first, and then the monitoring switch is triggered. Therefore, the disorder of the trigger sequence of the three switches occurs, which in turn affects the use safety.

With the microwave oven 1000 of the embodiment of the present disclosure, the first door hook 11 directly abuts with the monitoring switch to trigger the monitoring switch, the second door hook 12 directly abuts with the secondary switch to trigger the secondary switch, and the first door hook 11 triggers the primary switch through the drive lever 32a. In this way, the monitoring switch, the secondary switch, and the primary switch can be triggered sequentially, which avoids the problem of disorder of the trigger sequence of the switches.

As illustrated in FIG. 59 and FIG. 60, in some embodiments, the second door hook 12 and/or the first door hook 11 are fixed to the door body 200.

Thus, the second door hook 12 and the first door hook 11 can further ensure that the first switch 21a, the second switch 22a, and the third switch 23a are triggered sequentially.

In an exemplary embodiment of the present disclosure, each of the second door hook 12 and the first door hook 11 may be made of a metal such as iron, aluminum, stainless steel, and alloys. Each of the second door hook 12 and the first door hook 11 is in an elongated shape as a whole and has a hooked end to facilitate snap fit. In the embodiments of the present disclosure, the door body 200 includes two door hooks, i.e., the second door hook 12 and the first door hook 11. In some embodiments, the door body 200 may further include door hooks to assist in opening or closing the door. A quantity of door hooks may be set as desired. For example, three, four, or more than four door hooks may be provided. The present disclosure is not limited to any of these examples.

In an embodiment, the second door hook 12 is fixed to the door body 200, while the first door hook 11 is movably mounted at the door body 200. In another embodiment, the first door hook 11 is fixed to the door body 200, while the second door hook 12 is movably mounted at the door body 200. In yet another embodiment, the second door hook 12 and the first door hook 11 are fixed to the door body 200. In this way, the fixed door hook can ensure stability in triggering the switch to avoid situations such as late triggering and failed triggering due to a movement of the door hook. Fixing the door hook to the door body 200 can further ensure stability of a connection between the door hook and the door body 200.

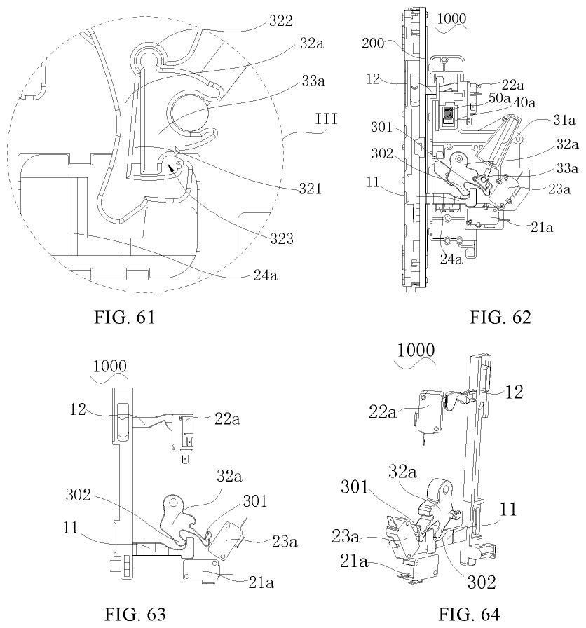

As illustrated in FIG. 60 and FIG. 61, in some embodiments, the damping assembly 30a further includes a swing block 33a rotatably connected to the drive lever 32a and the damper 31a.

In this way, the swing block 33a is rotatably connected to the drive lever 32a and the damper 31a, and thus a split-type rotational connection is realized, which can avoid unsmooth or even stuck door closing of the microwave oven 1000.

In an exemplary embodiment of the present disclosure, the damper 31a is rotatably connected to the drive lever 32a through the swing block 33a, realizing the split-type rotational connection. That is, the swing block 33a is rotatably connected to the drive lever 32a and the damper 31a. When the first door hook 11 applies a force to the drive lever 32a, the drive lever 32a rotates by a predetermined angle to drive the swing block 33a to compress the damper 31a. The damper 31a provides damping to the first door hook 11 and rotates when compressed. It should be understood that when the drive lever 32a drives the swing block 33a to rotate, a gap at a predetermined angle is available to keep the damper 31a from generating a damping effect when the first door hook 11 abuts with the drive lever 32a. Therefore, the unsmooth or even stuck door closing of the microwave oven 1000 is avoided.

It is worth mentioning that the damping assembly 30a is mounted at the interlock support 20, and the drive lever 32a is rotatably connected to the interlock support 20 through a rotational shaft at the interlock support 20. The damper 31a may be a linear damper. It should be understood that in other embodiments, the damper 31a may also be other dampers, such as a rotary damper.

As illustrated in FIG. 61, in some embodiments, the drive lever 32a has an accommodation groove 321. The accommodation groove 321 has a rotation space 322 formed at a top of the accommodation groove 321 and a swing space 323 formed at a bottom of the accommodation groove 321. The swing block 33a has an end rotatably accommodated in the rotation space 322 and another end accommodated in the swing space 323. The swing space 323 is configured to provide a space for the drive lever 32a to rotate relative to the swing block 33a.

In this way, the drive lever 32a can drive the swing block 33a to rotate after rotating by a predetermined angle.

In an exemplary embodiment of the present disclosure, the drive lever 32a has the accommodation groove 321. The accommodation groove 321 has the rotation space 322 at the top of the accommodation groove 321. The rotation space 322 is capable of accommodating a top end of the swing block 33a. In an embodiment, the rotation space 322 has a substantially cylindrical shape. The top end of the swing block 33a has a cylindrical shape matching the shape of the rotation space 322. The accommodation groove 321 has the swing space 323 at the bottom of the accommodation groove 321. The other end of the swing block 33a is accommodated in the swing space 323. The swing space 323 is configured to provide the space for the drive lever 32a to rotate by the predetermined angle.

The swing space 323 is configured and when the drive lever 32a starts to rotate, the swing block 33a will not be acted upon, which in turn prevents the damper 31a from being compressed. In this way, the first door hook 11 is free from a resistance of the damper 31a at beginning of abutment with the drive lever 32a, and thus a rebound issue or even a stuck issue can be avoided. A magnitude of the predetermined angle may be determined by a size of the swing space 323 and can be calibrated as desired.

As illustrated in FIG. 62, FIG. 63, and FIG. 64, in some embodiments, the drive lever 32a includes a first engagement region 301 and a second engagement region 302 spaced apart from each other. The first engagement region 301 has an accommodation groove 124. When moving towards the drive lever 32a, the first door hook 11 abuts with the first engagement region 301 after passing below the second engagement region 302, to drive the drive lever 32a to rotate. In this way, after the first door hook 11 drives the drive lever 32a to rotate, the second engagement region 302 can hook the first door hook 11 to drive the first door hook 11 to accelerate the door closing of the microwave oven 1000.

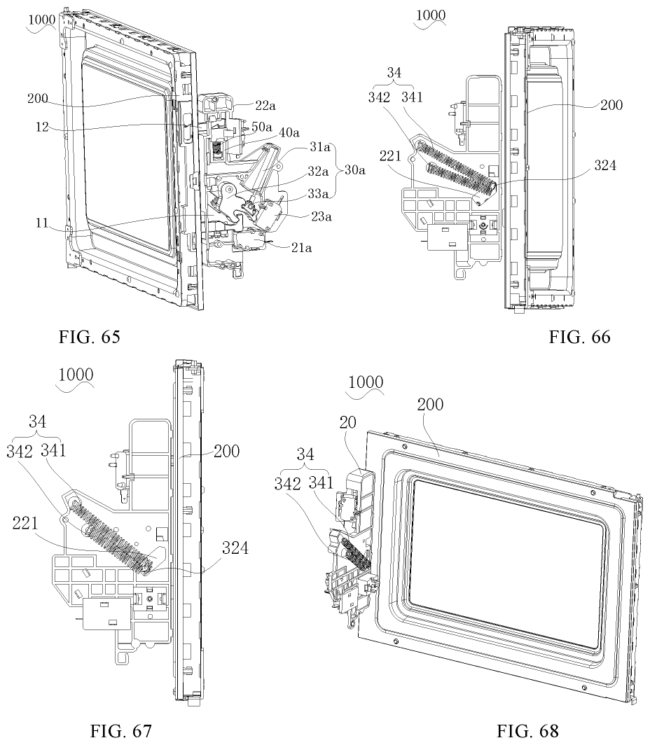

As illustrated in FIG. 65 to FIG. 68, in some embodiments, the damping assembly 30a includes the elastic member 34. The elastic member 34 and the drive lever 32a are located at two opposite sides of the interlock support 20. The interlock support 20 has the third through hole 221. The drive lever 32a is connected to the elastic member 34 through the third through hole 221. The elastic member 34 is configured to drive the drive lever 32a to accelerate a rotation, for enabling the drive lever 32a to drive the door body 200 to accelerate.

In this way, a process of first accelerating and then decelerating the first door hook 11 can be realized.

In an exemplary embodiment of the present disclosure, the elastic member 34 and the drive lever 32a located at the two opposite sides of the interlock support 20 can allow relevant structural members to be dispersed to avoid a space reduction and excessive weight concentration caused by arranging too many structural members at a same side surface of the interlock support 20, for a reason that such a space reduction and excessive weight concentration are inconducive to a configuration of the structural members.

The elastic member 34 is capable of providing a pulling force to the drive lever 32a, and the drive lever 32a drives the first door hook 11 to accelerate, or providing a pushing force to the drive lever 32a, and the drive lever 32a drives the first door hook 11 to accelerate. In the embodiment illustrated in FIG. 66 and FIG. 67, the elastic member 34 is configured to provide the pulling force to the dive lever 32a, and the drive lever 32a drives the first door hook 11 to accelerate.

Since the drive lever 32a can drive the first door hook 11 to accelerate, the door body 200 can be closed by a force from the drive lever 32a during an acceleration of the first door hook 11. During the acceleration of the first door hook 11, the damper 31a is compressed when the drive lever 32a rotates by the predetermined angle. As the door closing continues, the swing block 33a continues to compress the damper 31a. As an amount of compression of the damper 31a is increased, the damping force provided by the damper 31a is increased. When the damping force provided by the damper 31a is greater than the drive force provided by the drive lever 32a, the first door hook 11 begins to decelerate to enable the door body 200 to be closed without too much noise during a deceleration of the first door hook 11. In the embodiment of the present disclosure, when compressed, the damper 31a can rotate in a manner matching a rotation manner of a rotation member and the swing block 33a, allowing the first door hook 11 to enter a cavity smoothly.

In the embodiment illustrated in FIG. 59, the cover body 23 is further mounted at the interlock support 20 and an accommodation space is provided. The cover body 23 may be mounted at the interlock support 20 through screws, interference fit, welding, snap fit, or the like. In the embodiment illustrated in FIG. 59, the cover body 23 is mounted at the interlock support 20 through snap fit.

In some embodiments, when the first door hook 11 is separated from the drive lever 32a, a direction in which the elastic member 34 exerts a force to the drive lever 32a is directed to above a connecting line between a connection of the elastic member 34 with the drive lever 32a and a rotational axis of the drive lever 32a. When the first door hook 11 exerts a force to the drive lever 32a, a direction in which the elastic member 34 exerts a force to the drive lever 32a is directed to below a connecting line between a connection of the elastic member 34 with the drive lever 32a and the rotational axis of the drive lever 32a.

In this way, the drive lever 32a can have different rotation tendencies before and during the door closing of the microwave oven 1000, which is beneficial to realizing tight door closing of the microwave oven 1000.

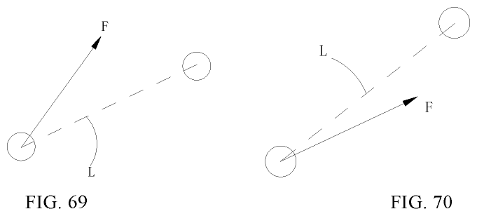

In some embodiments, as illustrated in FIG. 69, the direction in which the elastic member 34 exerts the force F to the drive lever 32a is directed to above the connecting line L between the connection of the elastic member 34 with the drive lever 32a and the rotational axis of the drive lever 32a. The drive lever 32a tends to rotate in the first direction under the force of the elastic member 34. As illustrated in FIG. 70, the direction in which the elastic member 34 exerts the force F to the drive lever 32a is directed to below the connecting line L between the connection of the elastic member 34 with the drive lever 32a and the rotational axis of the drive lever 32a. The drive lever 32a tends to rotate in the second direction under the force of the elastic member 34. The first direction is different from the second direction. In the figures, the first direction is the clockwise direction, and the second direction is the counterclockwise direction.

When the first door hook 11 has not yet abutted with the drive lever 32a, the drive lever 32a is stationary, and the force of the elastic member 34 acts on the drive lever 32a to allow the drive lever 32a to tend to rotate in the clockwise direction. When the first door hook 11 abuts with the drive lever 32a (e.g., the first engagement region 301), the drive lever 32a rotates in the counterclockwise direction under the force of the first door hook 11, allowing the connection of the elastic member 34 with the drive lever 32a also to rotate in the counterclockwise direction. When the direction in which the elastic member 34 exerts the force to the drive lever 32a is switched below the above-mentioned connecting line, the drive lever 32a changes from having a clockwise rotation tendency to a counterclockwise rotation tendency. In this case, the drive lever 32a is not limited, and continues to rotate in the counterclockwise direction under the force of the elastic member 34 to drive the first door hook 11 to accelerate.

Due to the rotation tendency change process of the drive lever 32a, the drive lever 32a has a great rotation angle. The first door hook 11 can be driven through the great rotation angle of the drive lever 32a to allow the door body 200 to be closed more tightly.

It should be noted that, in an initial state, a distance (angle) between a position of the connection between the elastic member 34 with the drive lever 32a and a critical position where a rotation tendency of the drive lever 32a changes is smaller than the predetermined angle. In an exemplary embodiment of the present disclosure, in the initial state, the position of the connection between the elastic member 34 with the drive lever 32a is close to the critical position where the rotation tendency of the drive lever 32a changes. In this way, when the first door hook 11 abuts with the drive lever 32a, the first door hook 11 having a high initial speed enables the drive lever 32a to rotate in the counterclockwise direction for a change in the rotation tendency. The rotation tendency can be changed without spending too much kinetic energy of the first door hook 11.

As illustrated in FIG. 66 and FIG. 67, in some embodiments, the elastic member 34 includes a first elastic member 341 and a second elastic member 342. The drive lever 32a is provided with a connection structure 324. Each of the first elastic member 341 and the second elastic member 342 is connected to the connection structure 324. An acute angle is formed between the first elastic member 341 and the second elastic member 342.

In this way, the drive lever 32a is driven by a resultant force of the first elastic member 341 and the second elastic member 342.

In an example embodiment of the present disclosure, during a rotation of the drive lever 32a, one elastic member may be stretched longer, while another elastic member may be compressed. A resultant force generated by the two elastic members varies slightly during the rotation of the drive lever 32a. Therefore, even when the door body 200 is closed properly, the drive lever 32a may exert a large abutment force on the first door hook 11 to allow the door body 200 to be closed more tightly. In an embodiment, both the first elastic member 341 and the second elastic member 342 may be tension springs. The first elastic member 341 is located above the second elastic member 342. One end of the first elastic member 341 is configured to hook a positioning post at the interlock support 20. Another end of the first elastic member 341 is configured to hook the connection structure 324. One end of the second elastic member 342 is configured to hook another positioning post at the interlock support 20. Another end of the second elastic member 342 is configured to hook the connection structure 324. The acute angle is formed between the first elastic member 341 and the second elastic member 342, which may be 30 degrees, 35 degrees, 40 degrees, etc.. The present disclosure is not specifically limited to any of these examples.

As illustrated in FIG. 60 and FIG. 62, in some embodiments, a protection block 24a is mounted at the interlock support 20. The protection block 24a is movably mounted at the interlock support 20. The protection block 24a is configured to limit the drive lever 32a when the first door hook 11 is separated from the drive lever 32a, and be driven by the first door hook 11 to move during the closing of the door body 200, to release the limit of the protection block 24a on the drive lever 32a.

In this way, the protection block 24a can prevent the drive lever 32a from rotating when the first door hook 11 is separated from the drive lever 32a.

In an exemplary embodiment of the present disclosure, the protection block 24a is capable of moving on the interlock support 20. A movement manner of the protection block 24a on the interlock support 20 includes movement, rotation, or other compound movements and is not limited herein, as long as the limit on the drive lever 32a can be made or released. In an embodiment, when the first door hook 11 is separated from the drive lever 32a, the protection block 24a can block the drive lever 32a from rotating, and the protection block 24a can move on the interlock support 20 in a vertical direction. When the door is closed, the first door hook 11 pushes the protection block 24a downwards in the vertical direction, which allows the protection block 24a to release the limit on the drive lever 32a and the drive lever 32a to rotate normally. In some embodiments, the protection block 24a has a limit groove configured to accommodate a part of the drive lever 32a. In a case where the part of the drive lever 32a is accommodated in the limit groove, the protection block 24a can block the drive lever 32a from rotating.

As illustrated in FIG. 60, in some embodiments, the microwave oven 1000 includes an inclined block 40a and a third elastic member 50a that are mounted at the interlock support 20. The third elastic member 50a abuts with a bottom of the inclined block 40a. The inclined block 40a has an inclined guide surface at a top of the inclined block 40a. The inclined guide surface is inclined upwardly towards an interior of the interlock support 20 in a vertical direction. The inclined guide surface is capable of abutting with an end of the second door hook 12 during the closing of the door body 200, to lower the inclined block 40a to compress the third elastic member 50a. The inclined block 40a is capable of catching the second door hook 12 through the third elastic element 50a when the end of the second door hook 12 moves across the inclined guide surface.

In this way, the second door hook 12 can be ensured to directly abut with the second switch 22a to trigger the second switch 22a through cooperation of the inclined block 40a and the third elastic member 50a with the second door hook 12.

In an exemplary embodiment of the present disclosure, the top of the inclined block 40a is the inclined guide surface inclined upwardly towards the interior of the interlock support 20 in a vertical direction. It should also be understood that an end of the inclined block 40a close to the second door hook 12 is located at a height lower than a height of an end of the inclined block 40a away from the second door hook 12. The inclined guide surface is an inclined plane having a predetermined angle. The second door hook 12 is capable of moving along the plane from below the plane to above the plane.

The third elastic member 50a includes a compression spring. The second door hook 12 is configured to exert a force on the inclined block 40a during the closing of the door body 200, to allow the third elastic member 50a to be kept in a compressed state. After the door body 200 is closed, the third elastic member 50a is stretched, and the inclined block 40a moves upwards under a force of the third elastic member 50a. The end of the inclined block 40a away from the second door hook 12 may be engaged with the second door hook 12. It is worth mentioning that, when the user opens or closes the door, a force required for opening the door is different from that required for closing the door. The force required for opening the door is usually greater than that required for closing the door. Therefore, the user can directly pull out the second door hook 12 from one end of the inclined block 40a with a great force to release the second door hook 12 from the inclined block 40a. Thus, a door opening structure can be simplified and the tight door closing of the microwave oven 1000 can be realized.

In some embodiments, the microwave oven 1000 further includes a cavity. The door body 200 is rotatably connected at a side of the cavity. The interlock support 20 is mounted in the cavity.

Thus, the cavity is used to store items or food. Mounting the interlock support 20 in the cavity can ensure stability of the mounting.

In an exemplary embodiment of the present disclosure, a household appliance 1000 may include a cavity (not illustrated in the figures). The interlock support 20 may be fixed to the cavity. The door body 200 is rotatably connected to the cavity. The cavity has a chamber having an opening at a front side of the chamber. The door body 200 is used for covering or exposing the opening. Food to be heated can be placed in the chamber.

The door body 200 is rotatably connected to a side of the cavity, for example a left side or a right side of a front plate of the cavity to form a side-open microwave oven 1000. The interlock support 20 may be fixed to the front plate of the cavity. The cavity has the chamber for storing items or food. The microwave oven 1000 can perform operations such as defrosting, cooking, or the like on items placed inside the chamber. In addition, the microwave oven 1000 further includes a housing outside the cavity. The housing can protect electrical and structural members inside the microwave oven 1000 and also avoid causing harm to the user.

Other compositions and operations of the microwave oven 1000 according to embodiments of the present disclosure, and thus details thereof will be omitted here.

In the description of the embodiments of the present disclosure, it should be noted that, unless otherwise clearly stipulated and limited, terms such as “mount”, “connect”, “connect to”, and the like should be understood in a broad sense. For example, it may be a fixed connection or a detachable connection or connection as one piece; mechanical connection or electrical connection; direct connection or indirect connection through an intermediate; internal communication of two components. The specific meaning of the above-mentioned terms in the present disclosure can be understood according to specific circumstances.

Throughout this specification, description with reference to “an embodiment,” “a specific embodiment,” “an example,” or the like means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Further, the particular features, structures, materials, or characteristics described here may be combined in any suitable manner in one or more embodiments or examples.

1. An interlock device of a microwave oven, the interlock device comprising:
a first door hook;
an interlock support provided with a monitoring switch, a first microswitch, and a second microswitch; and
a first lever and a second lever that are rotatably mounted at the interlock support, respectively,
wherein the first door hook is configured to sequentially drive the first lever and the second lever to rotate during door closing of the microwave oven, to allow the second lever to sequentially trigger the first microswitch and the second microswitch after the monitoring switch is triggered by the first lever.

2. The interlock device according to claim 1, wherein a rotational axis of the first lever is located at a side of a rotation axis of the second lever close to the first door hook.

3. The interlock device according to claim 1, wherein a rotational axis of the first lever and a rotational axis of the second lever are located at two sides of the first door hook perpendicular to a door closing direction, respectively.

4. The interlock device according to claim 1, wherein the first lever comprises a first drive arm provided with a first drive portion configured to trigger the monitoring switch; and
the first door hook is further configured to abut with the first drive arm during the door closing of the microwave oven to drive the first lever to rotate in a first direction.

5. The interlock device according to claim 4, wherein the first lever further comprises a second drive arm located at a side of the first drive arm close to the first door hook; and
the first door hook is further configured to:
extend to a position between the first drive arm and the second drive arm during the door closing of the microwave oven; and
abut with the second drive arm during door opening of the microwave oven to drive the first lever to rotate in a second direction opposite to the first direction.

6. The interlock device according to claim 5, further comprising an elastic member connected to the interlock support and the first lever and having a first drive state,
wherein the elastic member is configured to apply a drive force for rotating the first lever in the first direction to the first lever in the first drive state to allow the second drive arm to drive the first door hook to move in a door closing direction.

7. The interlock device according to claim 6, wherein the elastic member further has a second drive state;
the elastic member is further configured to apply a drive force for rotating the first lever in the second direction to the first lever in the second drive state; and
the first door hook is further configured to abut with the first drive arm during the door closing of the microwave oven to switch the elastic member from the second drive state into the first drive state.

8. The interlock device according to claim 5, wherein the second drive arm has a length smaller than a length of the first drive arm; and/or
in an axial direction of the first lever, the second drive arm has a thickness smaller than a thickness of the first drive arm.

9. The interlock device according to claim 4, wherein the interlock support is provided with a first limit portion, the first limit portion being configured to abut with the first lever in a door closed state to block the first lever from rotating in the first direction.

10. The interlock device according to claim 4, further comprising a door closing buffer assembly connected to the interlock support and the first drive arm,
wherein the door closing buffer assembly is configured to apply a buffer force to the first lever in a direction opposite to the first direction during the door closing of the microwave oven.

11. The interlock device according to claim 10, wherein the door closing buffer assembly comprises:
a buffer member having an end rotatably connected to the interlock support; and
a connector rotatably mounted at the first drive arm by a predetermined angle relative to a drive surface of the first drive arm, another end of the buffer member being rotatably connected to the connector,
wherein the drive surface is capable of abutting with the connector after the first lever rotates by the predetermined angle in the first direction during the door closing of the microwave oven, to drive the connector to rotate.

12. The interlock device according to claim 1, wherein the second lever comprises:
a first rotation arm configured to abut with the first door hook during the door closing of the microwave oven to drive the second lever to rotate in the second direction; and
a second rotation arm and a third rotation arm that are configured to trigger the first microswitch and the second microswitch, respectively,
wherein the first rotation arm, the second rotation arm, and the third rotation arm are sequentially arranged in the second direction.

13. The interlock device according to claim 12, wherein at least two of the first rotation arm, the second rotation arm, and the third rotation arm are offset from each other in an axial direction of the second lever.

14. The interlock device according to claim 1, wherein the interlock support comprises a support body and a cover body, the cover body cooperating with the support body to define a mounting space, and the first lever and the second lever being mounted in the mounting space;
the monitoring switch is arranged at a side of the cover body facing away from the support body;
the cover body has a first through hole for passage of the first drive portion of the first lever;
one of the first microswitch and the second microswitch is arranged in the mounting space, and another one of the first microswitch and the second microswitch is arranged at the side of the cover body facing away from the support body; and
the cover body has a second through hole for passage of a second drive portion of the second lever.

15. An interlock device of a microwave oven, the interlock device comprising:
a first door hook;
an interlock support provided with a first microswitch and a second microswitch; and
a second lever rotatably mounted at the interlock support, the second lever comprising a first rotation arm provided with a first cooperation portion, a second rotation arm provided with a second cooperation portion, and a third rotation arm provided with a third cooperation portion, and the first cooperation portion, the second cooperation portion, and the third cooperation portion being sequentially arranged about a rotational axis of the second lever in a first direction,
wherein the first door hook is configured to move in a door closing direction to abut with the first cooperation portion and drive the second lever to rotate in the first direction, to allow the third cooperation portion to trigger the second microswitch after the first microswitch is triggered by the second cooperation portion.

16. The interlock device according to claim 15, wherein the interlock support has a mounting space, the first cooperation portion extending into the mounting space, and the first door hook being configured to extend into the mounting space; and
a side wall of the mounting space has an avoidance recess, the first rotation arm being located at the avoidance recess, wherein the interlock support comprises a first shield plate partially shielding a communication opening where the avoidance recess is in communication with the mounting space,
wherein the interlock support has a mounting space,
wherein the second rotation arm is located in the mounting space; and
a second shield plate is provided in the mounting space, and a part of the second shield plate is at least located at a side of the second rotation arm close to the first door hook,
wherein the part of the second shield plate extends in the door closing direction and is located between the rotational axis of the second lever and the first door hook,
wherein the interlock support has a mounting space,
wherein the third rotation arm is located in the mounting space; and
a third shield plate is provided in the mounting space and is located at a side of the third rotation arm close to the first door hook,
wherein an angle formed between the first cooperation portion and the second cooperation portion with respect to an axis of the second lever is α; and
an angle formed between the second cooperation portion and the third cooperation portion with respect to the axis of the second lever is β, where α<β, wherein a spacing between the first cooperation portion and an axis of the second lever is greater than or equal to a spacing between the second cooperation portion and the axis of the second lever, and is greater than or equal to a spacing between the third cooperation portion and the axis of the second lever,
further comprising:
a monitoring switch provided at the interlock support; and
a first lever rotatably provided at the interlock support,
the first door hook is further configured to drive, before driving the second lever to rotate, the first lever to rotate in a second direction to trigger the monitoring switch,
wherein the first lever comprises:
a first drive arm provided with a first drive portion configured to trigger the monitoring switch; and
a second drive arm located at a side of the first drive arm close to the first door hook,
wherein the first door hook is further configured to abut with the first drive arm to drive the first lever to rotate;
wherein the first cooperation portion is configured to be positioned between the first drive arm and the second drive arm in a door closed state, wherein in an axial direction of the first lever, and the second drive arm has a thinned region located at least one surface of the second drive arm, and/or
an end of the first door hook has a thickness gradually decreasing in the door closing direction wherein the axial direction of the first lever the first drive arm is spaced apart from the first cooperation portion by a predetermined gap, further comprising an elastic member connected to the interlock support and the first lever, the elastic member having a first drive state in which the first lever is driven by the elastic member to rotate in the second direction and a second drive state in which the first lever is driven by the elastic member to rotate in the first direction,
wherein the first door hook is further configured to abut with the first lever during the door closing of the microwave oven to switch the elastic member into the first drive state from the second drive state, wherein the interlock support is provided with a first limit portion and a second limit portion,
wherein the first limit portion is configured to abut with the first lever for limiting in a door closed state; and
wherein the second limit portion is configured to abut with the first lever for limiting in a door opened state,
further comprising a door closing buffer assembly connected to the interlock support and the first lever,
wherein the door closing buffer assembly is configured to apply a buffer force to the first lever in a direction opposite to the second direction during the door closing of the microwave oven, wherein the door closing buffer assembly comprises:
a buffer member having an end rotatably connected to the interlock support; and
a connector rotatably mounted at the first drive arm by a predetermined angle relative to a drive surface of the first lever, another end of the buffer member being rotatably connected to the connector
wherein the drive surface is capable of abutting with the connector after the first lever rotates by the predetermined angle in the second direction during the door closing of the microwave oven, to drive the connector to rotate, wherein in an axial direction of the first lever, the connector has an avoidance notch formed at a side surface of the connector, the avoidance notch being configured to avoid the first cooperation portion.

17-31. (canceled)

32. A microwave oven, comprising:
a machine body;
a door body mounted at the machine body; and
the interlock device according to claim 1,
wherein the first door hook is mounted at the door body; and
wherein the interlock support is mounted at the machine body.

33. A microwave oven, comprising:
a door body having a first door hook and a second door hook;
an interlock support movably connected to the door body and fixedly provided with a first switch, a second switch, and a third switch;
a damping assembly mounted at the interlock support and comprising a damper and a drive lever, the drive lever being rotatably connected to the interlock support and the damper,
wherein the microwave oven is configured such that during closing of the door body, the first door hook directly abuts with the first switch to trigger the first switch, the second door hook directly abuts with the second switch to trigger the second switch, and the first door hook triggers the third switch through the drive lever.

34. The microwave oven according to claim 33, wherein the second door hook and/or the first door hook are fixed to the door body, wherein the damping assembly further comprises a swing block rotatably connected to the drive lever and the damper, wherein the drive lever has an accommodation groove, the accommodation groove having a rotation space formed at a top of the accommodation groove and a swing space formed at a bottom of the accommodation groove;
the swing block has an end rotatably accommodated in the rotation space and another end accommodated in the swing space; and
the swing space is configured to provide a space for the drive lever to rotate relative to the swing block, wherein the damping assembly comprises an elastic member the elastic member and the drive lever being located at two opposite sides of the interlock support;
the interlock support has a third through hole, the drive lever being connected to the elastic member through the third through hole, and
the elastic member is configured to drive the drive lever to accelerate rotation to allow the drive lever to drive the door body to accelerate wherein when the first door hook is separated from the drive lever, a direction in which the elastic member exerts a force to the drive lever is directed to above a connecting line between a connection of the elastic member with the drive lever and a rotational axis of the drive lever; and
when the first door hook exerts a force to the drive lever, a direction in which the elastic member exerts a force to the drive lever is directed to below a connecting line between a connection of the elastic member with the drive lever and the rotational axis of the drive lever, wherein the elastic member comprises a first elastic member and a second elastic member; and
the drive lever is provided with a connection structure,
wherein each of the first elastic member and the second elastic member is connected to the connection structure; and
wherein the acute angle is formed between the first elastic member and the second elastic member, wherein a protection block is movably mounted at the interlock support,
wherein the protection block is configured to:
limit the drive lever when the first door hook is separated from the drive lever; and
be driven by the first door hook to move to during the closing of the door body, to release the limit of the protection block on the drive lever, further comprising an inclined block and a third elastic member that are mounted at the interlock support,
wherein the third elastic member abuts with a bottom of the inclined block;
wherein the inclined block has an inclined guide surface at a top of the inclined block, the inclined guide surface being inclined upwardly towards an interior of the interlock support in a vertical direction;
wherein the inclined guide surface is capable of abutting with an end of the second door hook during the closing of the door body, to lower the inclined block to compress the third elastic member and the inclined block is capable of catching the second door hook through the third elastic element when the end of the second door hook moved across the inclined guide surface, further comprising a cavity,
wherein the door body is rotably the connected at a side of the cavity; and the interlock support is mounted in the cavity.

35-42. (canceled)
